(19) United States
(12) Patent Application Publication
(10) Pub. No.: US 2010/0026978 A1
(43) Pub. Date: Feb. 4, 2010

(54) PROJECTION OBJECTIVE OF A MICROLITHOGRAPHIC PROJECTION EXPOSURE APPARATUS

(75) Inventors: Johannes Ruoff, Aalen (DE); Aurelian Dodoc, Heidenheim (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 12/539,136

(22) Filed: Aug. 11, 2009

Related U.S. Application Data
(63) Continuation of application No. PCT/EP2008/052736, filed on Mar. 6, 2008.

(30) Foreign Application Priority Data
Mar. 13, 2007 (DE) 102007012563.3

(51) Int. Cl. G03B 27/54; G02B 5/30

(52) U.S. Cl. 355/67; 359/500

(57) ABSTRACT

The disclosure relates a projection objective of a microlithographic projection exposure apparatus, as well as a related microlithographic projection exposure apparatus and method. The projection objective can include a lens of a cubically crystalline material whose crystal orientation is oriented at an angle of at most 15° relative to the optical axis of the projection objective. The projection objective can also include a polarization correction element which has at least two subelements of birefringent, optically uniaxial material and having at least one respective aspheric surface. During use of the projection objective, the polarization correction element at least partially compensates for an intrinsic birefringence of the lens.

### CROSS-REFERENCE TO RELATED APPLICATIONS

This application is a continuation of, and claims benefit under 35 USC 120 to, international application PCT/EP2008/052736, filed Mar. 6, 2008, which claims benefit of German Application No. 10 2007 012 563.3, filed Mar. 13, 2007. International application PCT/EP2008/052736 is hereby incorporated by reference in its entirety.

### FIELD

The disclosure relates to a projection objective of a microlithographic projection exposure apparatus, as well as a related microlithographic projection exposure apparatus and method.

### BACKGROUND

Microlithographic projection exposure apparatuses can be used for the production of microstructured components such as for example integrated circuits or LCDs. Such a projection exposure apparatus typically has an illumination system and a projection objective. In the microlithography process, the image of a mask (=reticle) illuminated by the illumination system is projected by the projection objective onto a substrate (for example silicon wafer) which is coated with a light-sensitive layer (photoresist) and arranged in the image plane of the projection objective to transfer the mask structure onto the light-sensitive layer.

In microlithography objectives, such as immersion objectives with a value with respect to the numerical aperture (NA) of more than 1.5, it can be desirable to use materials with a high refractive index, in particular for the last optical element at the image side. The term “high refractive index” is used herein to denote a refractive index if its value at the given wavelength exceeds that of quartz, with a value of about 1.56 at a wavelength of 193 nm. An example of such a materialis lutetium aluminum garnet (Lu₃Al₅O₁₂, LuAG), which has a refractive index at 193 nm is about 2.14. In some cases, such materials, due to their cubic crystal structure, have intrinsic birefringence (═IBR) which rises with a low wavelength. For example, measurements for lutetium aluminum garnet have given a maximum IBR-induced retardation of 30.1 nm/cm. The term “retardation” is used herein to denote the difference in the optical paths of two orthogonal (mutually perpendicular) polarization states.

### SUMMARY

In some embodiments, the disclosure provides a projection objective of a microlithographic projection exposure apparatus, which permits the use of high-refraction crystal materials while limiting an undesirable influence of intrinsic birefringence.

In certain embodiments, the disclosure provides a projection objective of a microlithographic projection exposure apparatus, which is configured to project a mask which can be positioned in an object plane of the projection objective onto a light-sensitive layer which can be positioned in an image plane of the projection objective. The projection objective includes at least one lens of a cubically crystalline material whose [110] crystal orientation is oriented at an angle of at most 15° relative to the optical axis of the projection objective. The projection objective also includes at least one polarization correction element which has at least two subelements of birefringent, optically uniaxial material and having at least one respective aspheric surface. The polarization correction element at least partially compensates for an intrinsic birefringence of the at least one lens.

Reference to the optical axis denotes a straight line or a succession of straight line portions, which extends through the centers of curvature of the rotationally symmetrical optical components of the projection objective.

In some embodiments, the [110] crystal orientation of the at least one lens of cubically crystalline material is oriented at an angle of at most 10° (e.g., at most 5°, at most 3°) relative to the optical axis of the projection objective.

The disclosure is based, in part at least, on the realization that the field-dependent residual retardation remaining in the case of polarization-optical compensation of an intrinsically birefringent lens (and in particular a lens which is the last at the image plane side) by a polarization correction element depends on the crystal orientation of that lens. The disclosure makes use of the realization that a reduction in that residual retardation can be achieved if the crystal orientation of the lens to be compensated with respect to its intrinsic birefringence is so selected that the maximum retardation values in the field distribution of that lens occur on or in the proximity of the optical lens of the projection objective.

The [110] crystal orientation that is selected for the lens to be compensated with respect to its intrinsic birefringence has the property that light beams which pass in axis-parallel relationship through the [110] lens experience the maximum retardation (in contrast, for example, to the situation with a [100] lens which does not have any retardation for light beams passing thereto in axis-parallel relationship). In addition the disclosure makes use of the fact that, by using a suitable polarization correction element, it is possible to completely compensate for the intrinsic birefringence for any field point (for example a field point on the optical axis) while that compensation only takes place partially for the other field points.

When designing the polarization correction element for optimum polarization-optical compensation of the retardation of the lens to be compensated with respect to its intrinsic birefringence, in the field center, it is possible by the combination of a polarization correction element on the one hand and a lens with [110] crystal orientation which is to be compensated with respect to its intrinsic birefringence on the other hand, to create a situation in which the maximum retardation of the [110] lens is optimized for axis-parallel beams in the field center.

In some embodiments, the polarization correction element includes a crystal material with a non-cubic crystal structure. For example, the polarization correction element can include an optically uniaxial crystal material, such as magnesium fluoride (MgF₂), lanthanum fluoride (LaF₃), sapphire (Al₂O₃) or crystalline quartz (SiO₂).

In certain embodiments, the polarization correction element can have at least three subelements (optionally, precisely three subelements) of birefringent material and with at least one respective aspheric surface. With such a polarization correction element it is possible to achieve at least almost complete compensation of intrinsic birefringence for any field point (for example the field center).

More generally, the polarization correction element can have at least two subelements of birefringent material, with each sublement having at least one aspheric surface.

In some embodiments, the birefringent material of the subelements of the polarization correction element is an optically uniaxial crystal material. The birefringent material of the subelements of the polarization correction element can be, for example, magnesium fluoride (MgF₂), lanthanum fluoride (LaF₃), sapphire (Al₂O₃) or crystalline quartz (SiO₂).

In certain embodiments, the lens is the last lens of the projection objective on the image plane side of the projection objective. For the field center, it is possible to minimize a field-dependent residual error with respect to polarization-optical compensation, that is caused by the typically planoconvex geometry of the last lens on the image plane side, as (in contrast to the situation for example in the case of the coma rays or edge rays of the different field beams) the principal rays which are in axis-parallel relationship in the image plane and which are near the axis pass through substantially the same optical travel length in the last lens on the image plane side.

In some embodiments, the projection objective has precisely one lens of a cubically crystalline material whose [110] crystal orientation is oriented at an angle of at most 15° relative to the optical axis of the projection objective. The disclosure makes use of the fact that the combination of a polarization correction element on the one hand and a lens with [110] crystal orientation on the other hand, in regard to the polarization-optical compensation which can be achieved, possibly makes the presence of further [110] lenses with lens clocking dispensable.

In certain embodiments, the optical crystal axes of all three subelements are oriented differently from each other.

In some embodiments, the optical crystal axes of at least two subelements of the polarization correction element are oriented in a plane perpendicular to the optical axis of the projection objective.

In certain embodiments, the disclosure provides a projection objective of a microlithographic projection exposure apparatus, for projecting a mask which can be positioned in an object plane onto a light-sensitive layer which can be positioned in an image plane. The projection objective includes precisely one lens of a cubically crystalline material that has its [110] crystal orientation oriented at an angle of at most of 15° relative to the optical axis the projection objective. The projection objective also includes a polarization correction element which has an optically uniaxial crystal material and at least partially compensates for an intrinsic birefringence of the lens.

The disclosure makes use of the realization that the combination of a polarization correction element on the one hand and a lens with [110] crystal orientation on the other hand, in regard to the polarization-optical compensation which can be achieved, possibly makes the presence of further [110] lenses with lens clocking dispensable.

In some embodiments, the disclosure provides a projection objective of a microlithographic projection exposure apparatus, for projecting a mask which can be positioned in an object plane onto a light-sensitive layer which can be positioned in an image plane. All lenses of cubically crystalline material in the projection objective have their [110] crystal orientation oriented at an angle of at most 15° relative to the optical axis of the projection objective. The projection objective also includes a polarization correction element which has an optically uniaxial crystal material and at least partially compensates for an intrinsic birefringence of the one or more lenses.

The disclosure also relates to a microlithographic projection exposure apparatus, a process for the production of microlithographic components, and a microlithographic component.

Further configurations of the disclosure are to be found in the description and the claims.

### BRIEF DESCRIPTION OF THE DRAWINGS

FIG. 1 shows an overall meridional section through a complete catadioptric projection objective;

FIGS. 2a-b show a diagrammatic view of the typical configuration of partial rays of different beams in a first lens on the object plane side and a last lens on the image plane side of a projection objective;

FIG. 3 shows an overall meridional section through a complete catadioptric projection objective;

FIGS. 4a-b show the residual retardation (in nm) obtained for the projection objective of FIG. 1 without polarization correction element in the case of a [100] crystal orientation of the last lens on the image plane side (FIG. 4a) and for the case of a [110] crystal orientation of the last lens on the image plane side (FIG. 4b);

FIGS. 5a-c show height profiles (in μm) of the respective subelements of a polarization correction element used for IBR compensation of the last lens on the image plane side with [100] crystal orientation;

FIGS. 6a-b show the residual retardation (in nm) obtained with a polarization correction element as shown in FIGS. 5a-c for the field center (FIG. 6a) and the field edge (FIG. 6b);

FIGS. 7a-c show height profiles (in μm) of the respective subelements of a polarization correction element used for IBR compensation of the last lens on the image plane side with [110] crystal orientation;

FIGS. 8a-b show the residual retardation (in nm) obtained with a polarization correction element as shown in FIGS. 7a-c for the field center (FIG. 8a) and the field edge (FIG. 8b);

FIGS. 9a-b show the residual retardation (in nm) obtained for the projection objective of FIG. 3 without polarization correction element in the case of a [100] crystal orientation of the last lens on the image plane side (FIG. 9a) and for the case of a [110] crystal orientation of the last lens on the image plane side (FIG. 9b);

FIGS. 10a-c show height profiles (in μm) of the respective subelements of a polarization correction element used for IBR compensation of the last lens on the image plane side with [100] crystal orientation;

FIGS. 11a-b show the residual retardation (in nm) obtained with a polarization correction element as shown in FIGS. 10a-c for the field center (FIG. 11a) and the field edge (FIG. 11b),

FIGS. 12a-c show height profiles (in μm) of the respective subelements of a polarization correction element used for IBR compensation of the last lens on the image plane side with [110] crystal orientation; and

FIGS. 13a-b show the residual retardation (in nm) obtained with a polarization correction element as shown in FIGS. 12a-c for the field center (FIG. 13a) and the field edge (FIG. 13b).

### DETAILED DESCRIPTION

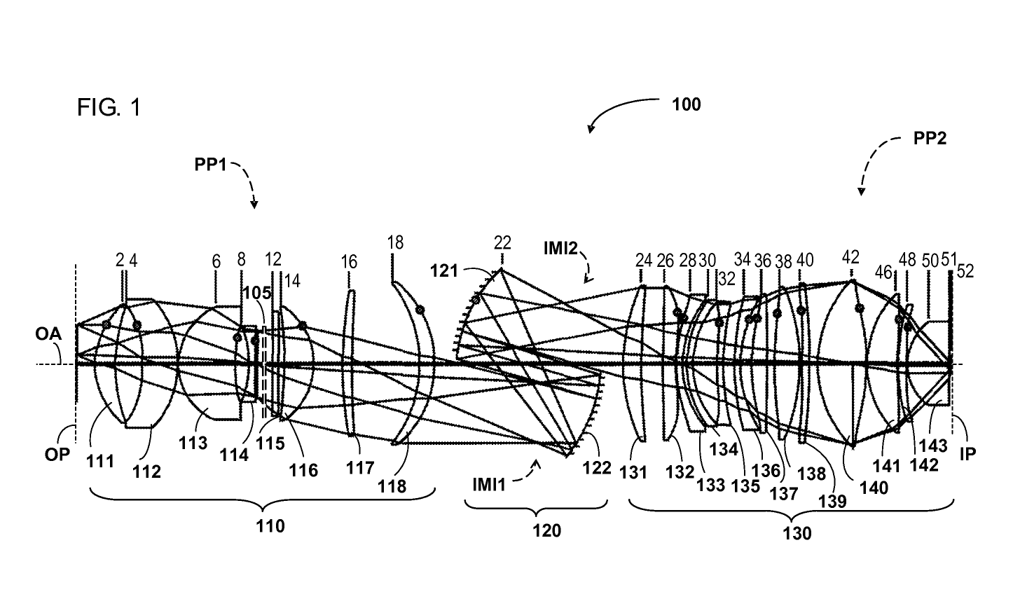

FIG. 1 shows an exemplary projection objective 100. The design data of exemplary projection objective 100 are set out in Table 1, where column 1 represents the number of the respective refracting or in some other fashion distinguished optical surface, column 2 specifies the radius r of that surface (in mm), column 3 gives a reference to an asphere present on that surface, column 4 specifies the spacing, identified as thickness, of that surface relative to the following surface (in mm), column 5 specifies the material following the respective surface, column 6 specifies the refractive index of that material at λ=193 nm and column 7 specifies the optically useable free half diameter of the optical component. The radii, thicknesses and half diameters are specified in millimeters.

The surfaces identified by thick dots in FIG. 1 and specified in Tables 1 and 2 are aspherically curved, wherein the curvature of those surfaces is given by the following asphere formula:

$$P ( h ) = \frac{( 1 / r ) \cdot {h}^{2}}{1 + \sqrt{1 - ( 1 + cc ) {( 1 / r )}^{2} {h}^{2}}} + {C}_{1} {h}^{4} + {C}_{2} {h}^{6} + … \qquad ( 1 )$$

P denotes the camber height of the surface in question parallel to the optical axis, h denotes the radial spacing from the optical axis, r denotes the radius of curvature of the surface in question, cc denotes the conical constant (identified by K in Table 2) and C1, C2, . . . denote the asphere constants set out in Table 2.

Referring to FIG. 1 the projection objective 100 has a catadioptric structure with a first optical subsystem 110, a second optical subsystem 120 and a third optical subsystem 130. As used herein, “subsystem” always denotes such an arrangement of optical elements, by which a real object is projected into a real image or intermediate image. In other words each subsystem, starting from a given object or intermediate image plane, always includes all optical elements to the next real image or intermediate image.

The first optical subsystem 110 includes an arrangement of refractive lenses 111-118 and reproduces the object plane “OP” in a first intermediate image IMI1, the approximate position of which is indicated in FIG. 1 by an arrow. That first intermediate image IMI1 is reproduced by the second optical subsystem 120 in a second intermediate image IMI2, the approximate position of which is also indicated in FIG. 1 by an arrow.

The second optical subsystem 120 includes a first concave mirror 121 and a second concave mirror 122 which are each “cut off” in a direction perpendicular to the optical axis in such a way that light propagation can occur from the respective reflecting surfaces of the concave mirrors 121, 122 to the image plane “IP”. The second intermediate image IMI2 is reproduced in the image plane IP by the third optical subsystem 130.

The third optical subsystem 130 includes an arrangement of refractive lenses 131-143. In regard to the last lens 143 at the image plane side this involves a planoconvex lens with a lens surface which is convexly curved on the object plane side. Lens 143 is a [110] lens with its [110] crystal orientation that is oriented at an angle of at most 15° relative to the optical axis (OA).

Between the light exit surface of the lens 143 and the light-sensitive layer arranged in the image plane IP in the region of the projection objective 100 is an immersion liquid which in the illustrated embodiment, at a working wavelength of 193 nm, has a refractive index of n_{Imm}≈1.65. An immersion liquid which is suitable for example for that purpose bears the designation “Dekalin”. A further suitable immersion liquid is cyclohexane (n_{Imm}≈11.57 at 193 nm).

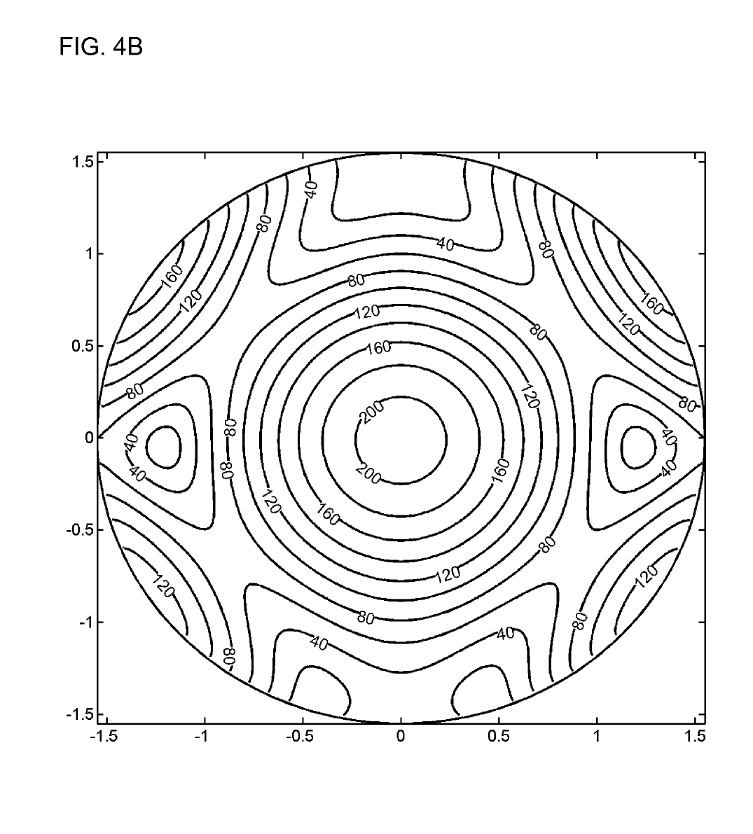

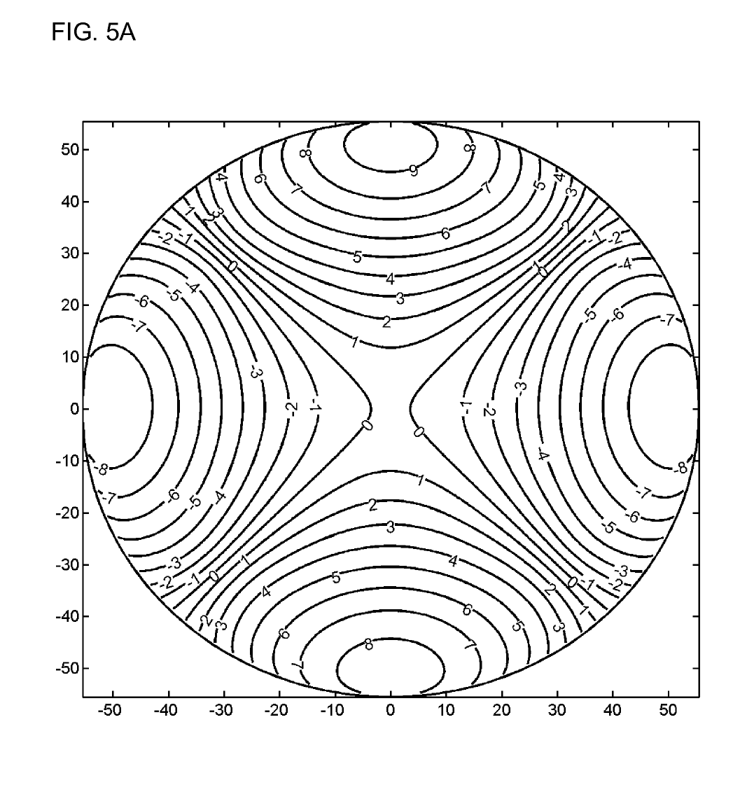

Disposed in the pupil plane PP1 is a polarization correction element 105, the structure of which is described in greater detail hereinafter with reference to FIGS. 4 through 8.

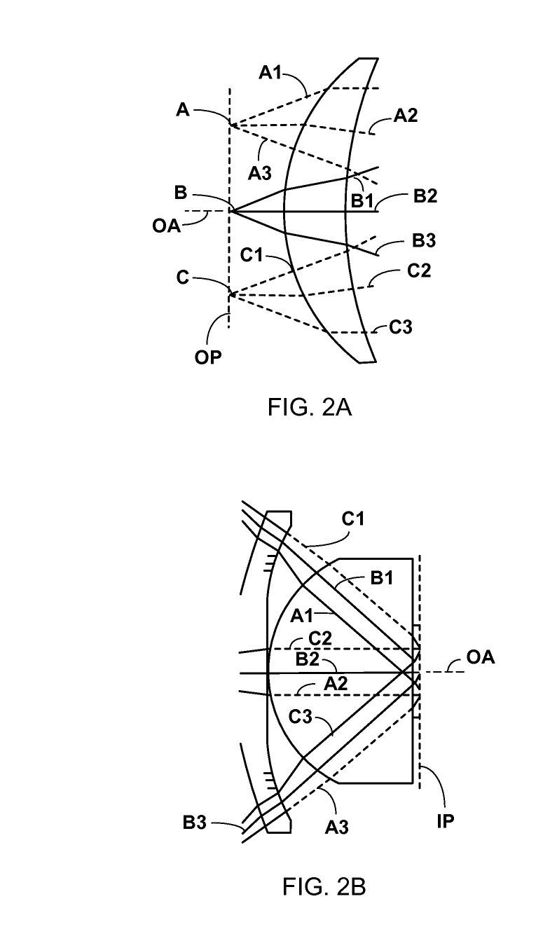

The reduction or minimization achieved with respect to the field-dependent residual retardation as a consequence of the combination of a polarization correction element with a lens which is last on the image plane side with [110] crystal orientation is described in greater detail hereinafter with reference to FIGS. 2a-b.

FIGS. 2a and 2b diagrammatically show the typical configuration of three respective subrays of three individual light beams in a lens which is first on the object plane side (FIG. 2a) and the lens which is last on the image plane side (FIG. 2b) on an enlarged scale. The coma rays of those beams A, B and C are denoted in FIGS. 2a and 2b by A1, A3, B1, B3, C1 and C3. The principal rays of the beams A, B and C are denoted in FIGS. 2a and 2b by A2, B2 and C2. Those principal rays extend substantially parallel to the optical axis OA with double-side (and thus in particular image-side) telecentry of the projection objective within the last lens on the image plane side. As is further apparent from FIG. 2b the optical travel lengths of those principal rays A2, B2 and C2 within the last lens on the image plane side are almost equal so that those subrays also experience substantially the same retardation and can be equally well compensated by a polarization correction element.

In contrast for example the subray C3 of the beam C within the last lens on the image plane side as shown in FIG. 2b covers a substantially greater optical distance than the subray C1 of the same beam C. That difference is responsible for the above-mentioned field-dependent residual error of the polarization-optical compensation effect which can be achieved by a polarization correction element, or the residual retardation achieved, and is correspondingly greater, the greater the spread angle of the individual beams.

It follows from the foregoing description that the polarization-optical compensation which can be achieved by the polarization correction element with respect to the last lens on the image plane side is particularly effective, in the field center. The fact that the last lens is in the [110] crystal orientation means that the particular effectiveness of a polarization correction element which is optimized for the field center is advantageously combined with a maximum retardation in the intrinsically birefringent [110] crystal material of that last lens.

The effect of that advantageous combination is clear from a comparison of FIGS. 4 through 8.

FIGS. 4a and b show the residual retardation (in nm) obtained for the projection objective of FIG. 1 without polarization correction element, more specifically in the case of a [100] crystal orientation of the last lens on the image plane side (FIG. 4a) and for the case of a [110] crystal orientation of the last lens on the image plane side (FIG. 4b). It will be seen that the residual retardations are respectively approximately at 200 nm, wherein the maximum residual retardation is achieved in the case of the [100] crystal orientation at the field edge and in the case of the [110] crystal orientation in the field center. In this respect, here and hereinafter the respective axes are specified in the diagrams for representing the residual retardation, in pupil coordinates, that is to say in the value range of −NA through +NA (NA=numerical aperture).

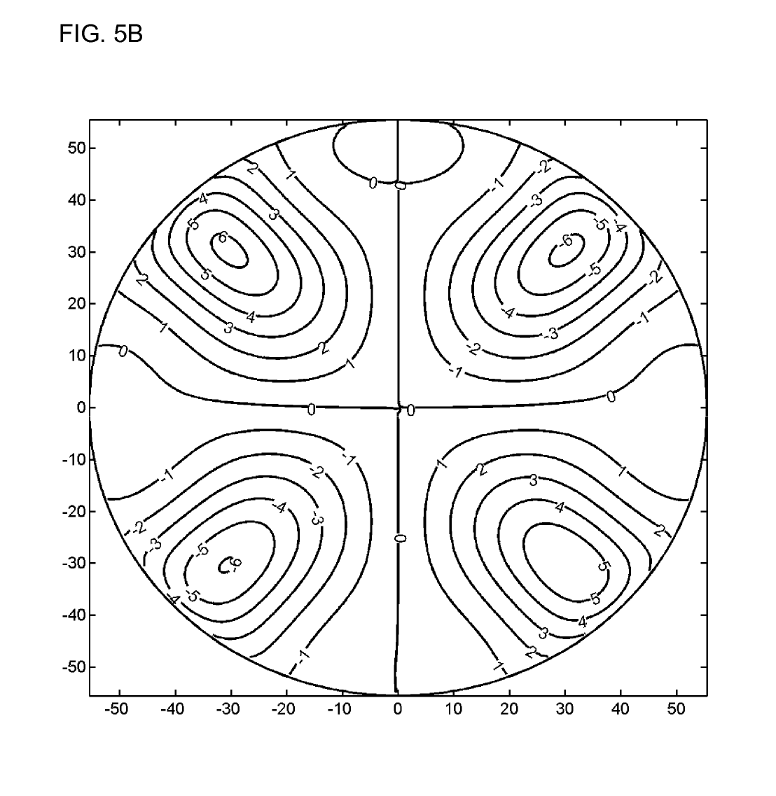

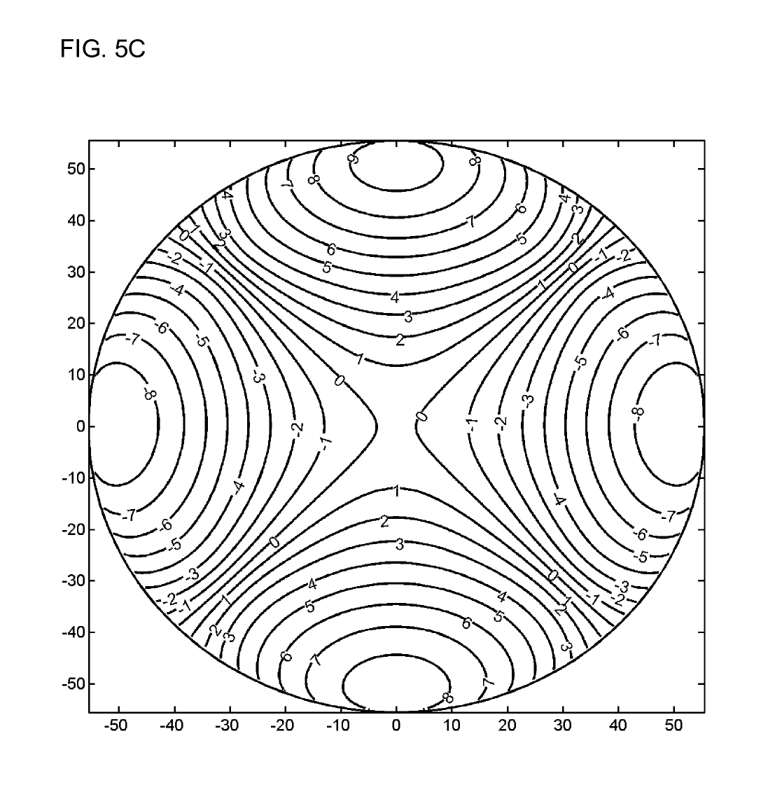

FIG. 5a-c show the height profiles (in μm) of three subelements of a polarization correction element for IBR compensation in the case of the [100] lens of FIG. 4a. In this case, here and hereinafter, the respective axes are specified in mm in the diagrams for representing height profiles.

The three subelements are respectively made from sapphire (Al₂O₃). The optical crystal axes in those three subelements are respectively disposed in a plane perpendicular to the optical axis OA of the projection objective and are so oriented that the optical crystal axis of the second subelement in the light propagation direction is arranged rotated through 45° about the optical axis OA with respect to the optical crystal axis of the first subelement while the optical crystal axis of the third subelement in the light propagation direction is again arranged parallel to the optical crystal axis of the first subelement. In some embodiments, the third subelement can also be arranged rotated for example through an angle of 90° about the optical axis OA with respect to the optical crystal axis of the first subelement (and through 45° about the optical axis OA with respect to the optical crystal axis of the second subelement) so that then the optical crystal axes of all three subelements are differently oriented.

The positive or negative height data contained in the height profiles of FIGS. 5a-c of the three subelements are respectively specified relative to the thickness of a plane plate with an effective retardation of a wavelength (or generally an integral multiple of the wavelength, that is to say relative to a plane plate of the thickness D=N*λ/Δn with Δn=nₑ−nₒ).

A further quantitative description of the height profiles of the three subelements is shown in Table 5 which contains the Zernike coefficients of the surfaces so scaled that a respective height profile in micrometers is afforded, more specifically in accordance with the relationship:

$$height profile = {\sum }_{i} ( {C}_{i} * {Z}_{i} ( r / {r}_{max} , phi ) \qquad ( 2 )$$

Cᵢ denotes the Zernike coefficients in Table 5, phi denotes the azimuth angle, r/rₘₐₓ denotes the standardized radial coordinate and Zᵢ denotes the i-th standard Zernike polynomial, where the maximum radii rₘₐₓ in the projection objective 100 are 55.47800 mm for the first subelement, 55.48200 mm for the second subelement and 55.48500 mm for the third subelement.

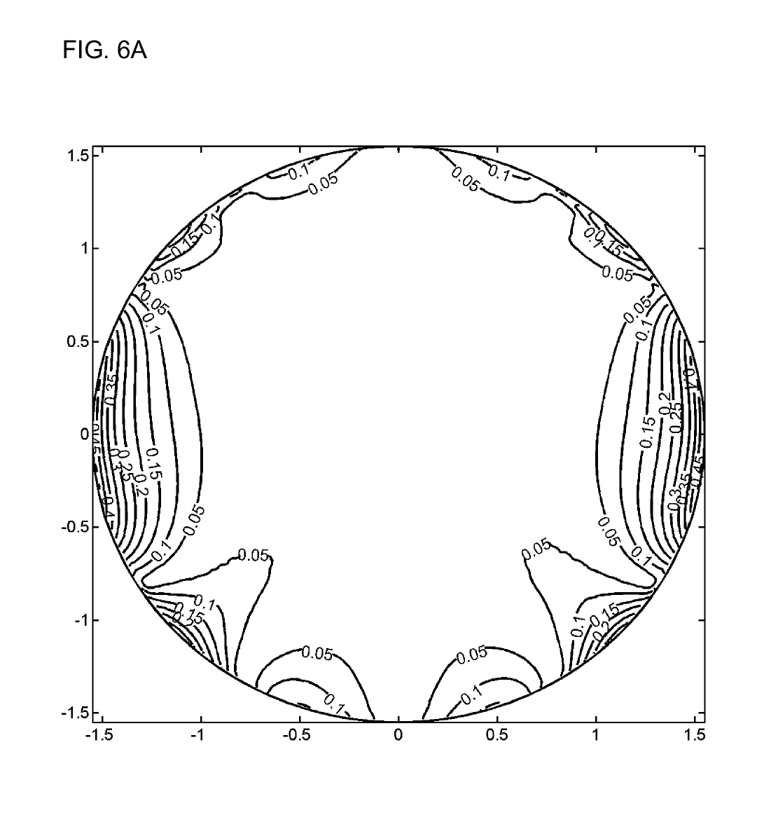

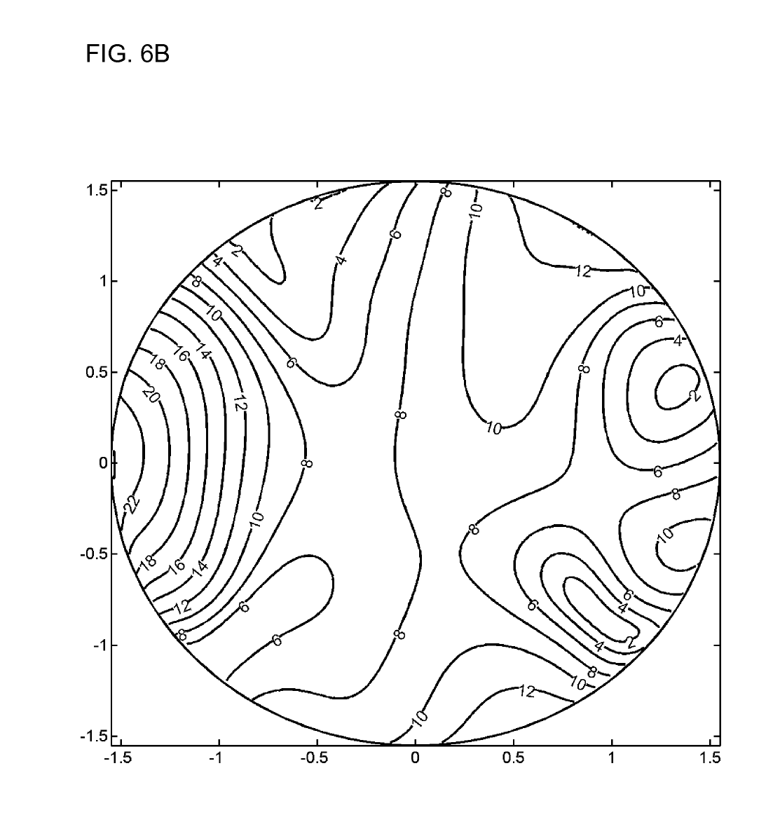

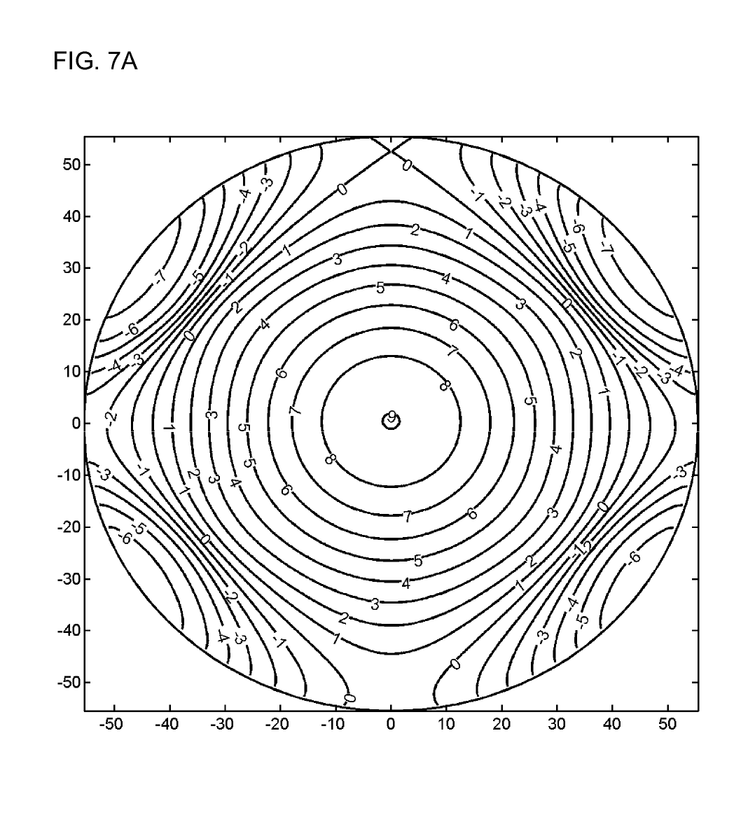

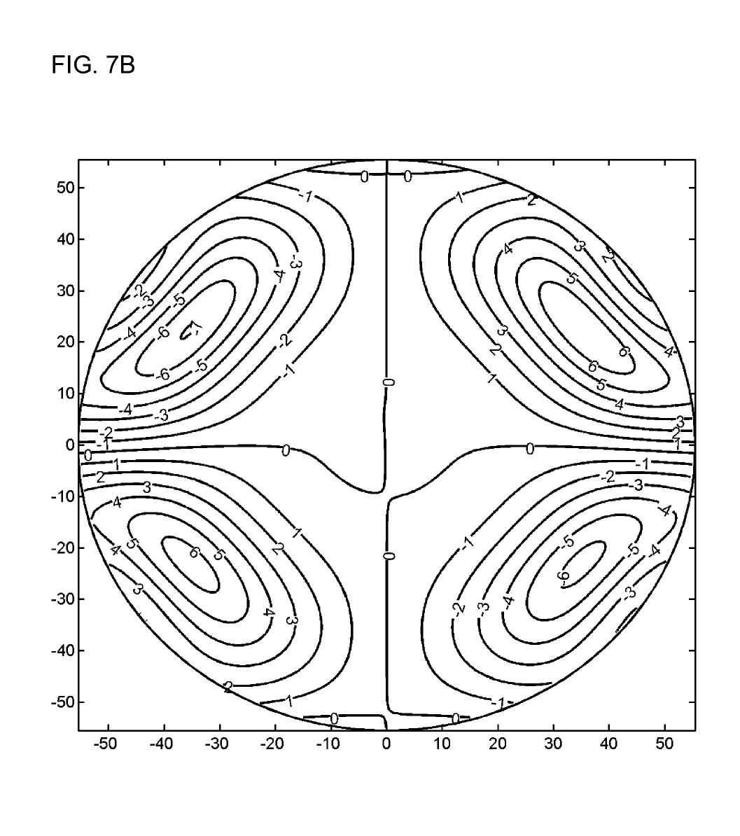

The residual retardation achieved by that polarization correction element is shown in FIG. 6a for the field center and in FIG. 6b for the field edge. While FIG. 6a shows almost complete compensation for the field center, FIG. 6b shows that there is still a maximum residual retardation of 24 nm for the field edge.

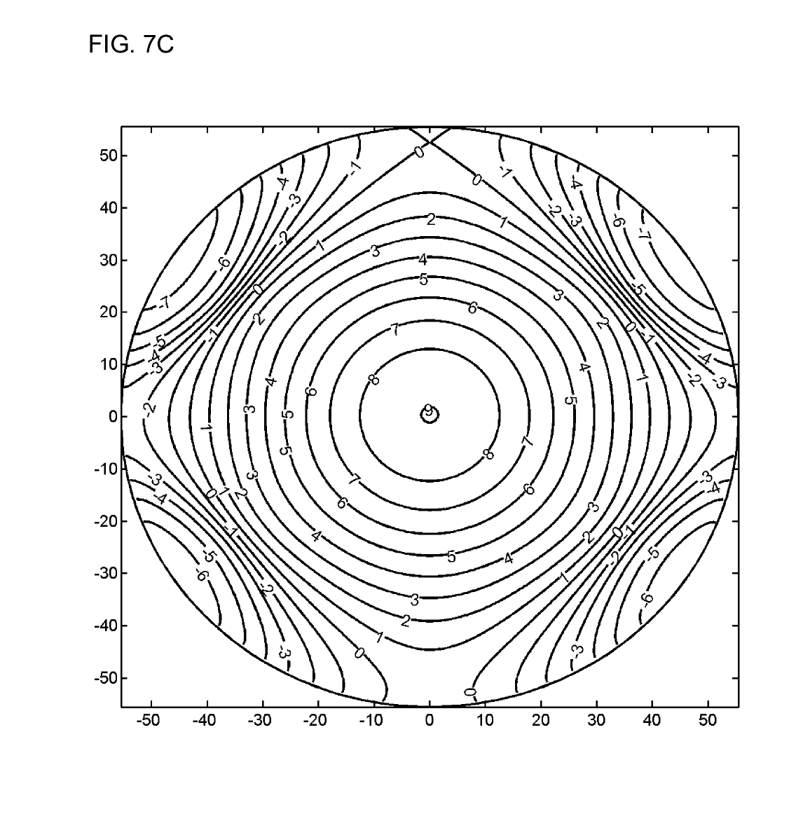

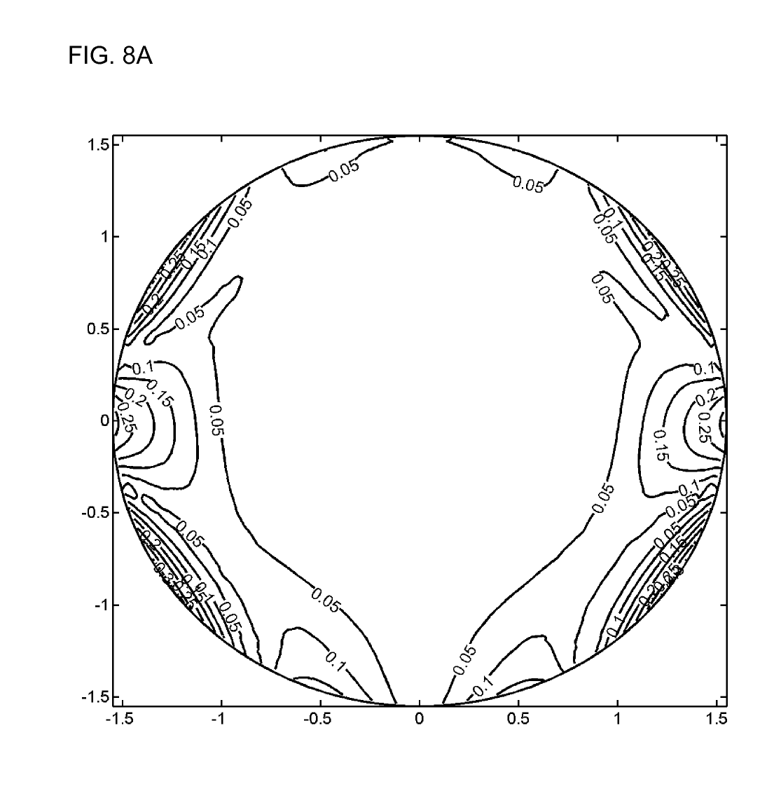

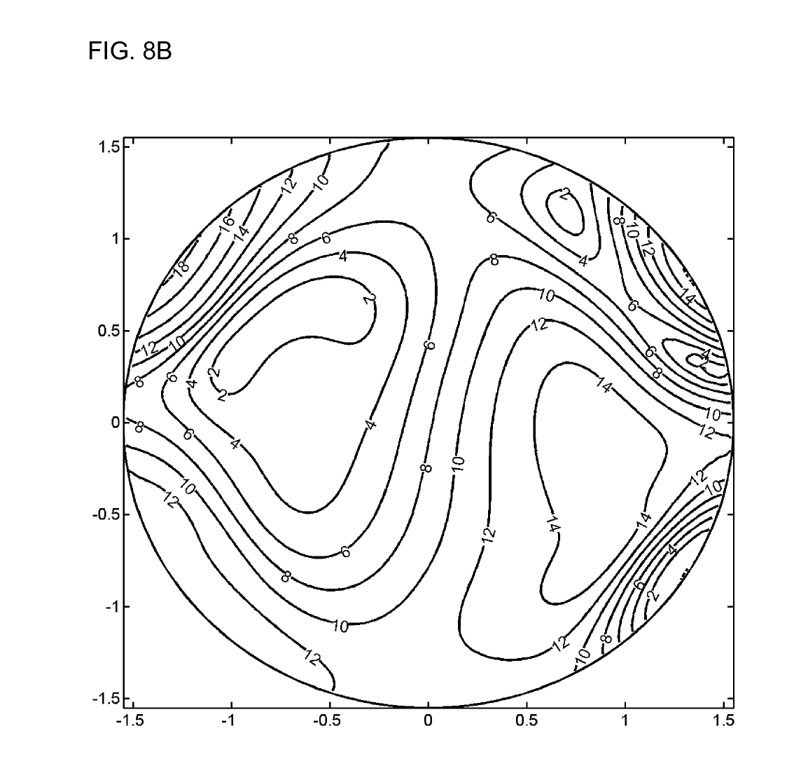

Similarly FIGS. 7a-c show the height profiles (in μm) of the subelements of a polarization correction element used for IBR compensation of the [110] lens as shown in FIG. 4b, where Table 6 contains the corresponding Zernike coefficients in accordance with the foregoing description. FIG. 8a shows the residual polarization obtained by that polarization correction element for the field center (FIG. 8a) and the residual retardation obtained for the field edge (FIG. 8b). While in FIG. 8a optimum compensation is still obtained for the field center the residual retardation for the field edge is only still a maximum of 18 nm as shown in FIG. 8b.

Of the subelements of the polarization correction element two or more (in particular all) of those subelements can also be assembled seamlessly (for example by wringing). In addition compensation elements (for example of optically isotropic material) for compensation of a beam deflection can also be associated with one or more (in particular all) of those subelements.

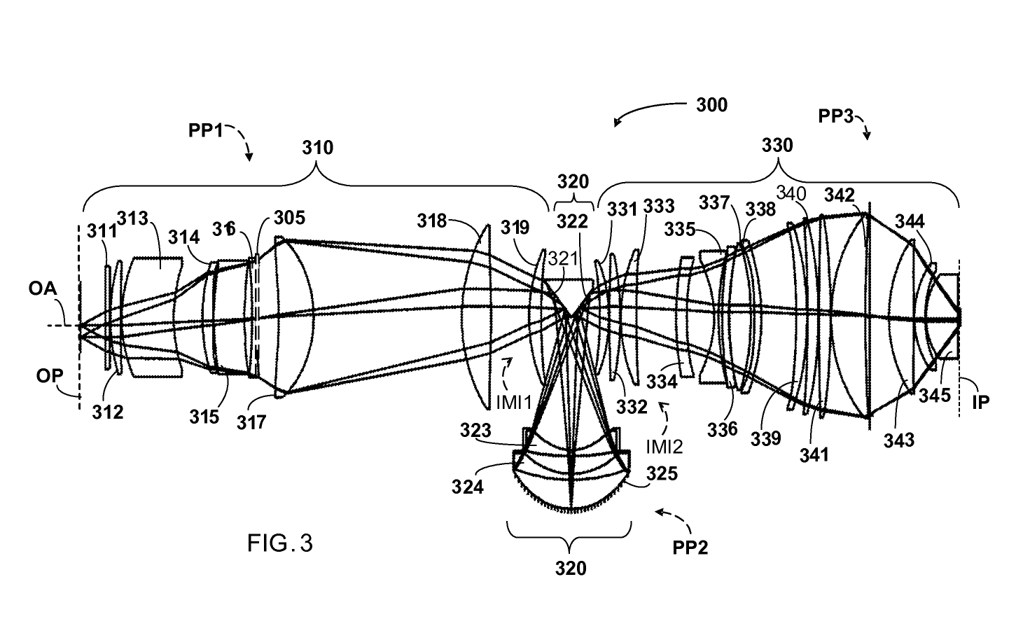

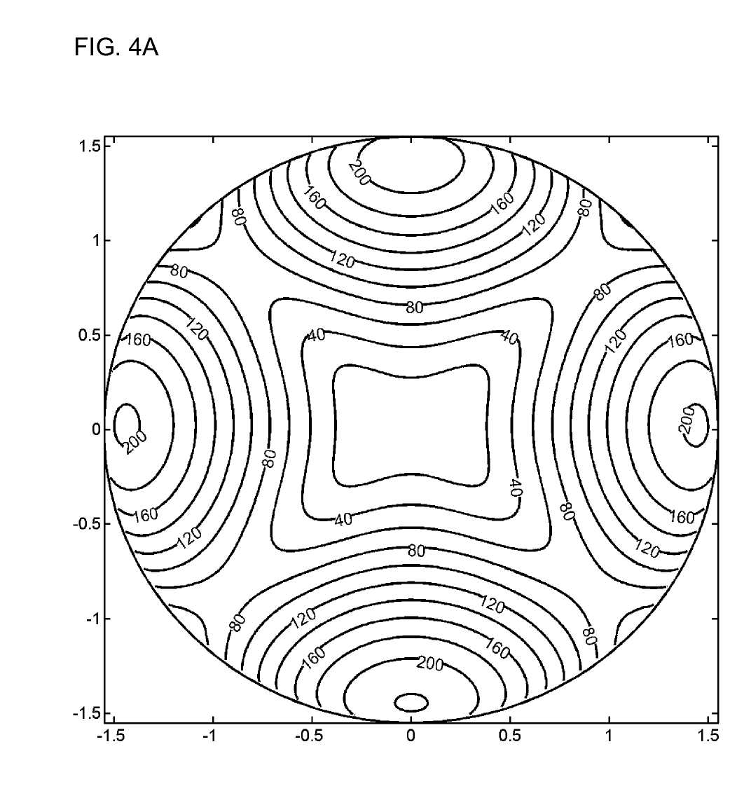

FIG. 3 shows a complete projection objective 300 in meridional section in accordance. The design data of that projection objective 300 are set out in Table 3 (in a similar fashion to Table 1) and the aspheric constants are to be found in Table 4.

The projection objective 300 includes a first refractive subsystem 310, a second catadioptric subsystem 320 and a third refractive subsystem 330 and is therefore also referred as a “RCR system”.

The first refractive subsystem 310 includes refractive lenses 311 through 319, after which a first intermediate image IMI1 is produced in the beam path. The second subsystem 320 includes a double-folding mirror with two mirror surfaces 321 and 322 arranged at an angle relative to each other, where light incident from the first subsystem is reflected firstly at the mirror surface 321 in the direction towards lenses 323 and 324 and a subsequent concave mirror 325. The light reflected at the concave mirror 325 is reflected after again passing through the lenses 323 and 324 at the second mirror surface 322 of the double-fold mirror so that as the outcome the optical axis OA is folded twice through 90°. The second subsystem 320 produces a second intermediate image IMI2 and the light from that intermediate image IMI2 is incident on the third refractive subsystem 330 which includes refractive lenses 331 through 345. The second intermediate image IMI2 is reproduced on the image plane IP by the third refractive subsystem 330.

The concave mirror 325 of the second catadioptric subsystem permits in per se known manner effective compensation of the image field curvature produced by the subsystems 310 and 330.

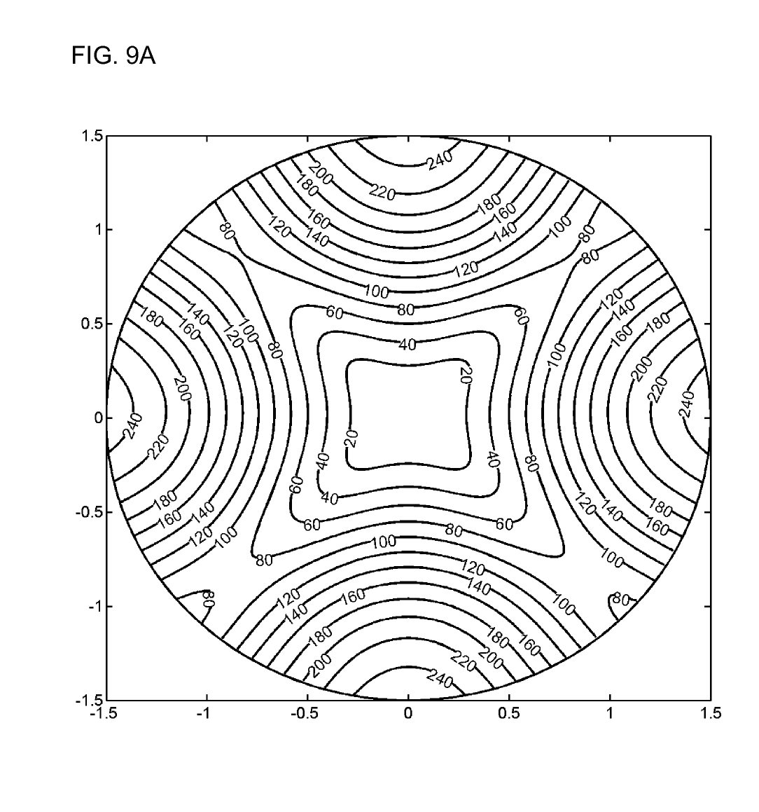

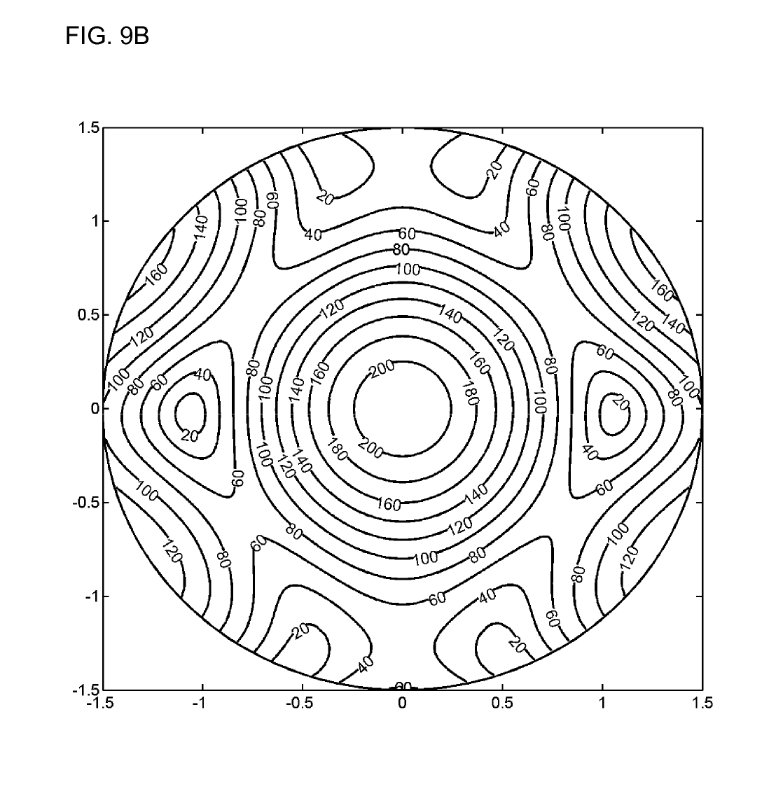

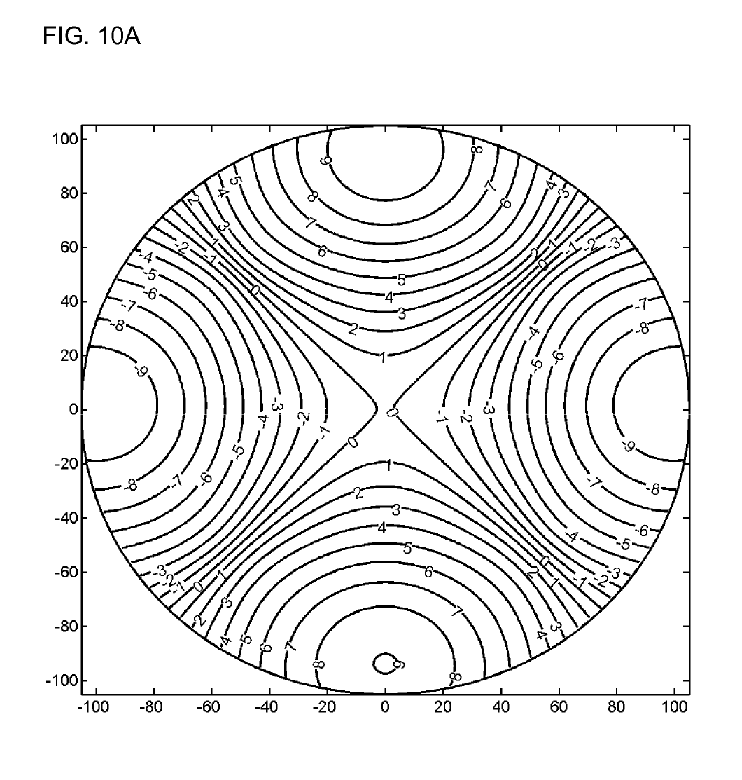

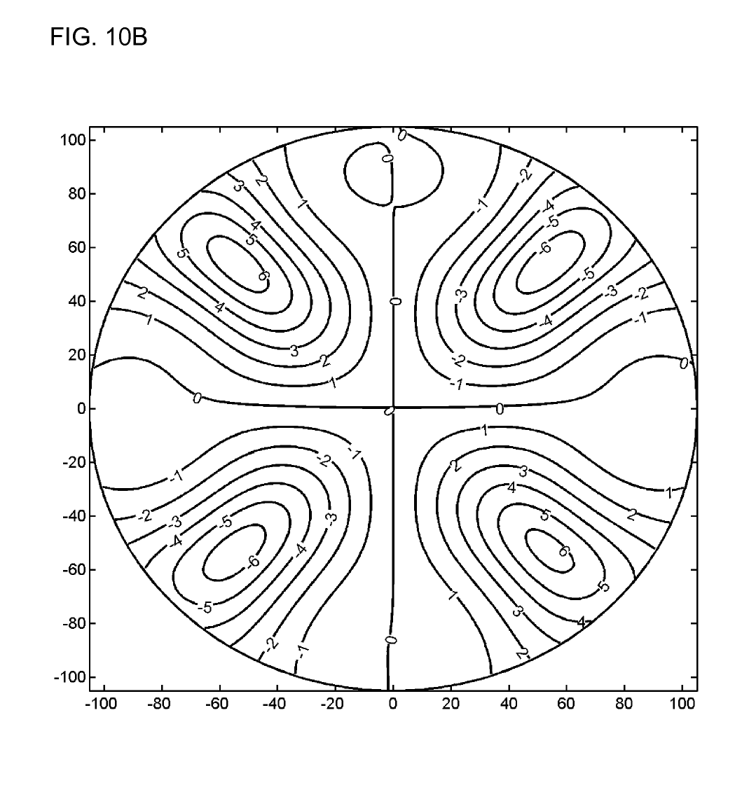

A polarization correction element 305 is disposed in the first pupil plane PP1 of the projection objective 300. The structure of the element 305 is described in greater detail hereinafter with reference to FIGS. 9 through 13.

FIGS. 9a and 9b show residual retardation (in nm) obtained for the projection objective 300 of FIG. 3 without polarization correction element, in the case of a [100] crystal orientation of the last lens on the image plane side (FIG. 9a) and in the case of a [110] crystal orientation of the last lens on the image plane side (FIG. 9b).

The optical crystal axes in those three subelements are again respectively disposed in a plane perpendicularly to the optical axis OA of the projection objective and are oriented similarly to the optical crystal axes in the three subelements of the polarization correction element in the exemplary embodiment of FIG. 1 and FIGS. 4 through 8, respectively.

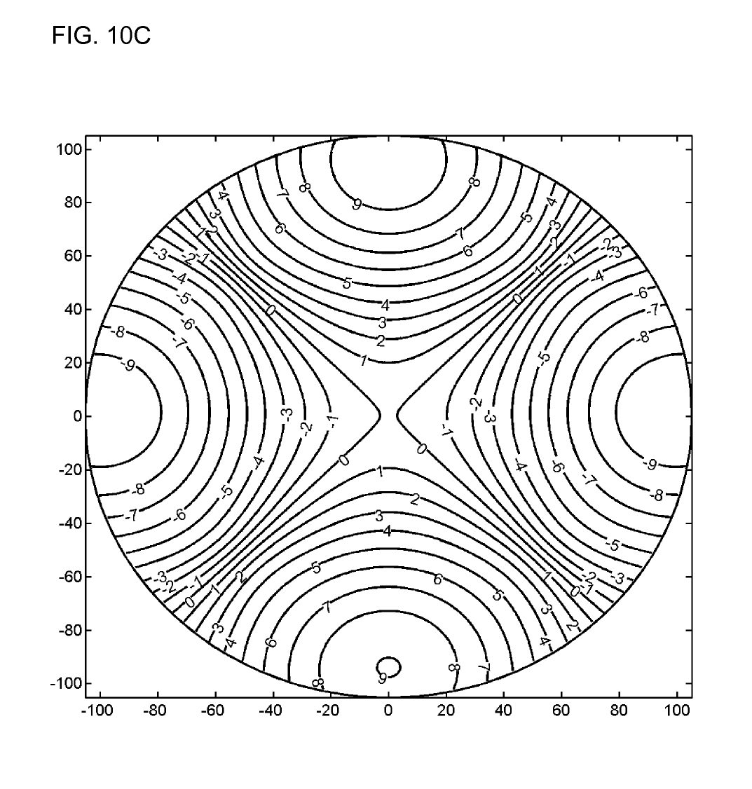

FIGS. 10a-c show the height profiles (in μm) of three subelements of a polarization correction element for IBR compensation in the case of the [100] lens of FIG. 9a.

A further quantitative description of the height profiles of the three subelements is set forth in Table 7 which contains the Zernike coefficients of the surfaces so scaled that a respective height profile in micrometers is afforded, in accordance with foregoing relationship (2). In that case the maximum radii rₘₐₓ in the projection objective 300 are 10.50640 mm for the first subelement, 10.51220 mm for the second subelement and 10.51810 mm for the third subelement.

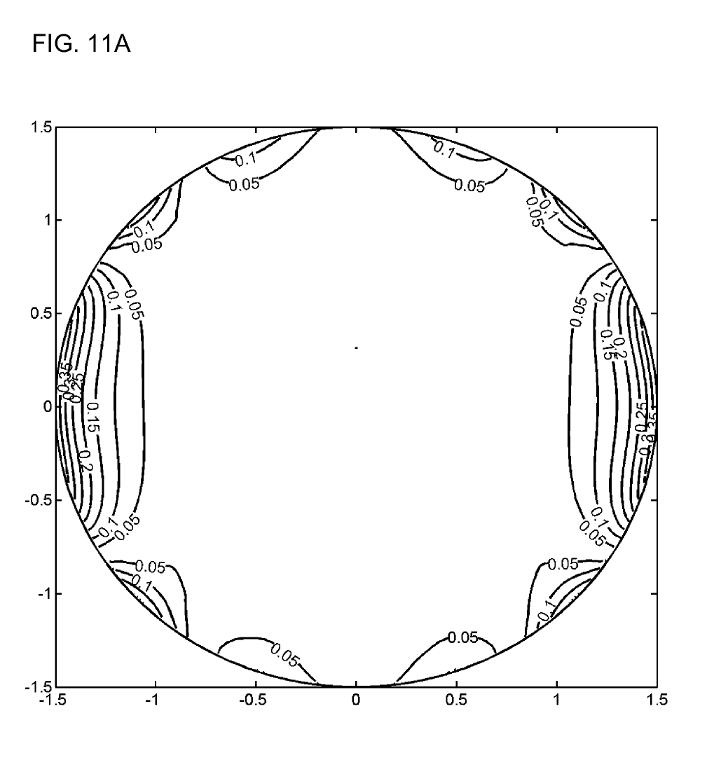

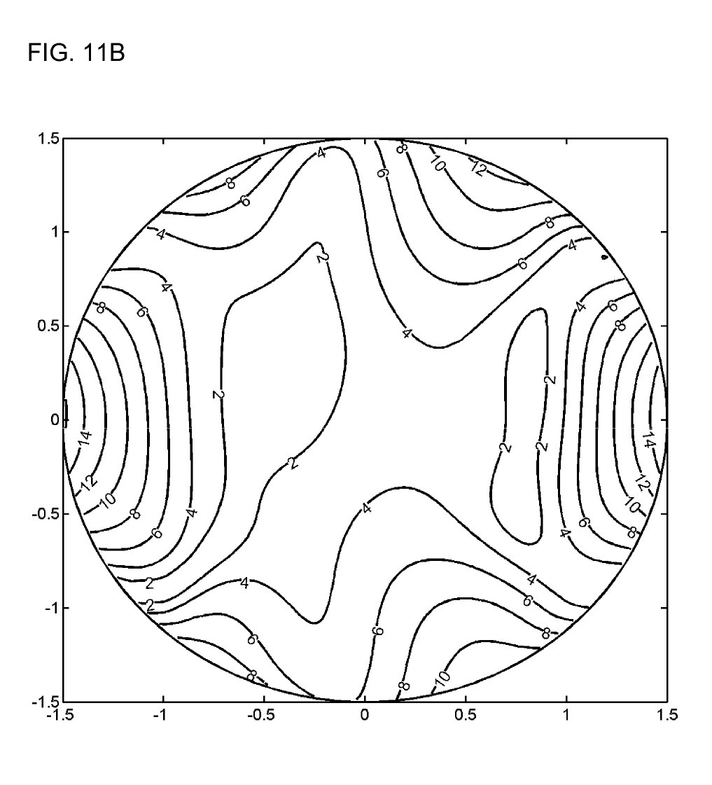

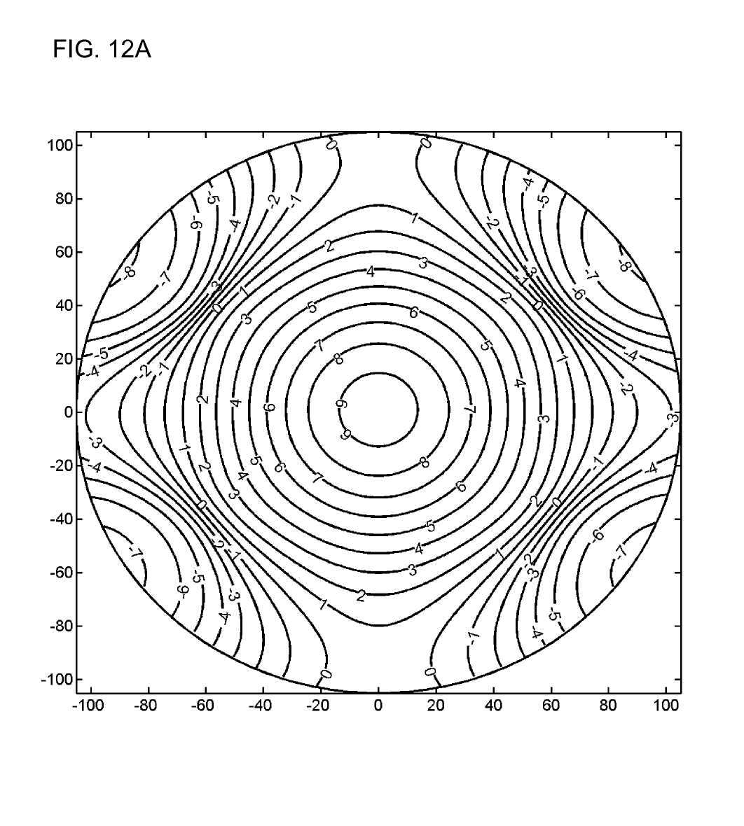

The residual retardation obtained by that polarization correction element is shown in FIG. 11a for the field center and in FIG. 11b for the field edge. While FIG. 11a shows almost complete compensation for the field center, FIG. 11b shows that there is still a maximum residual retardation of 16 nm for the field edge.

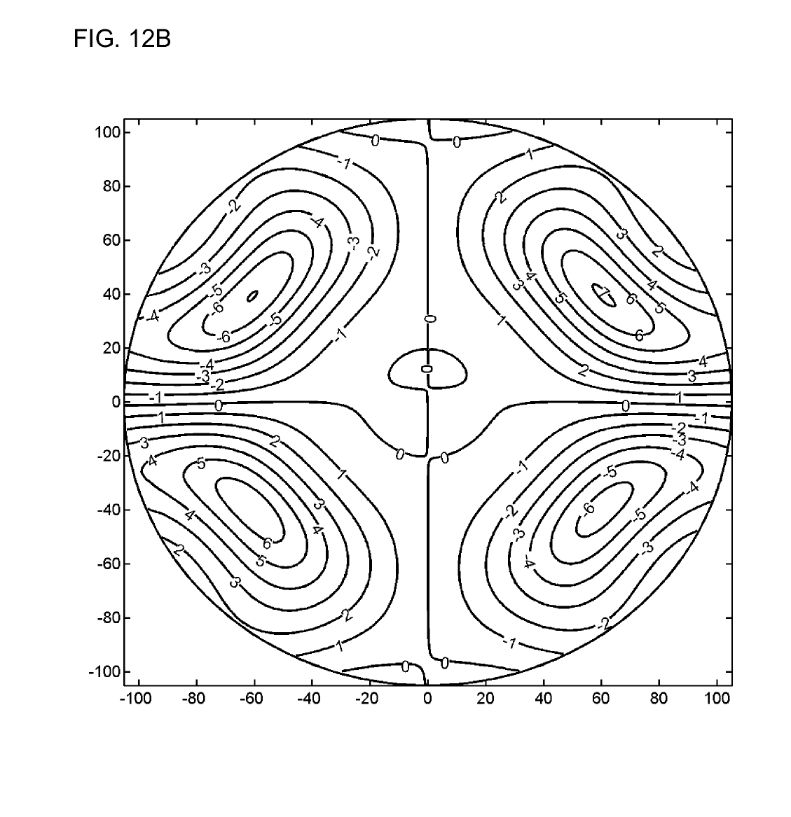

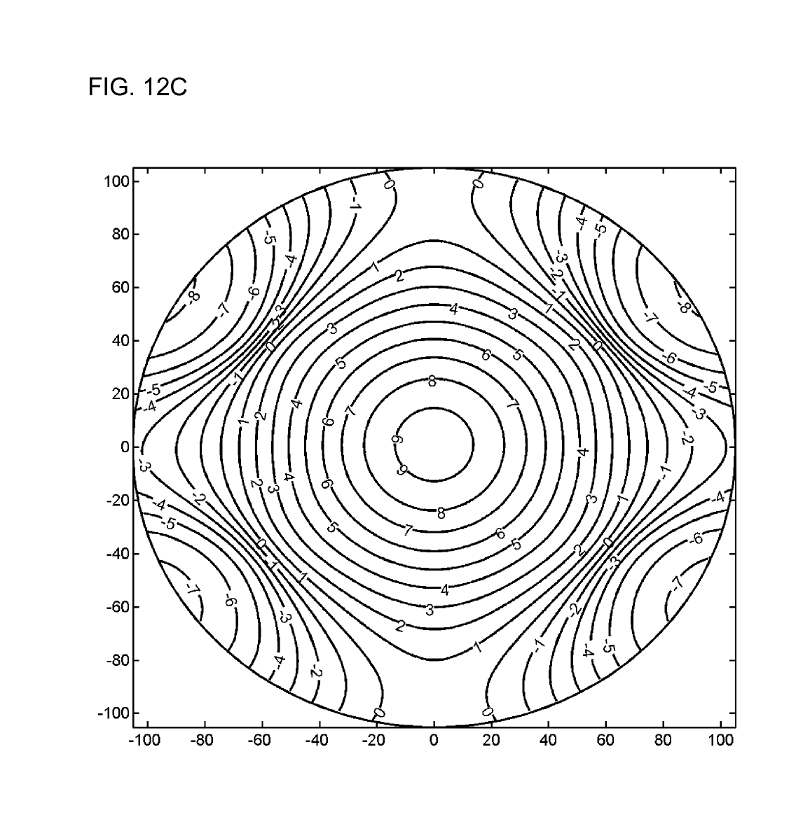

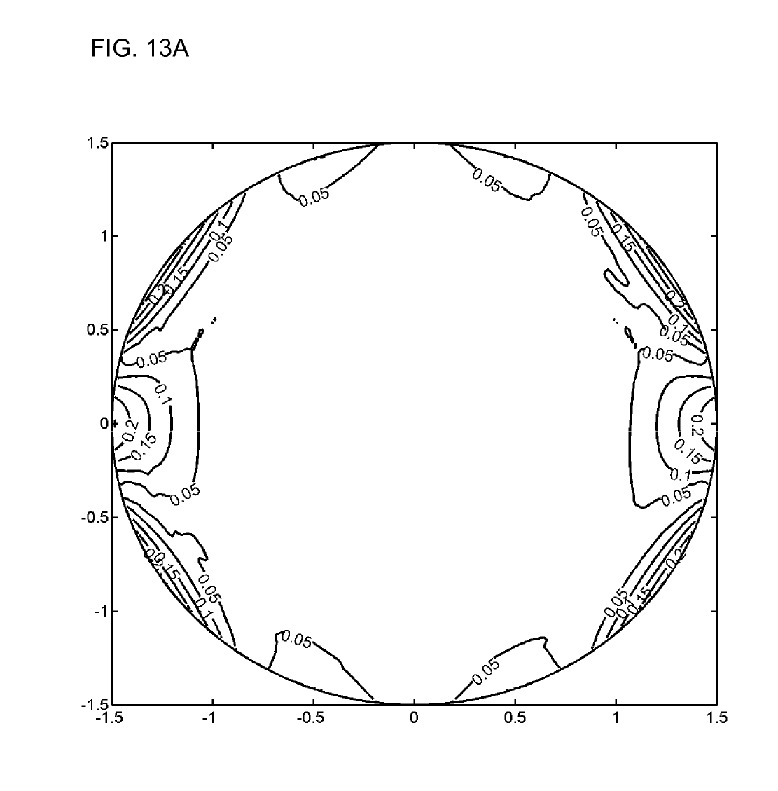

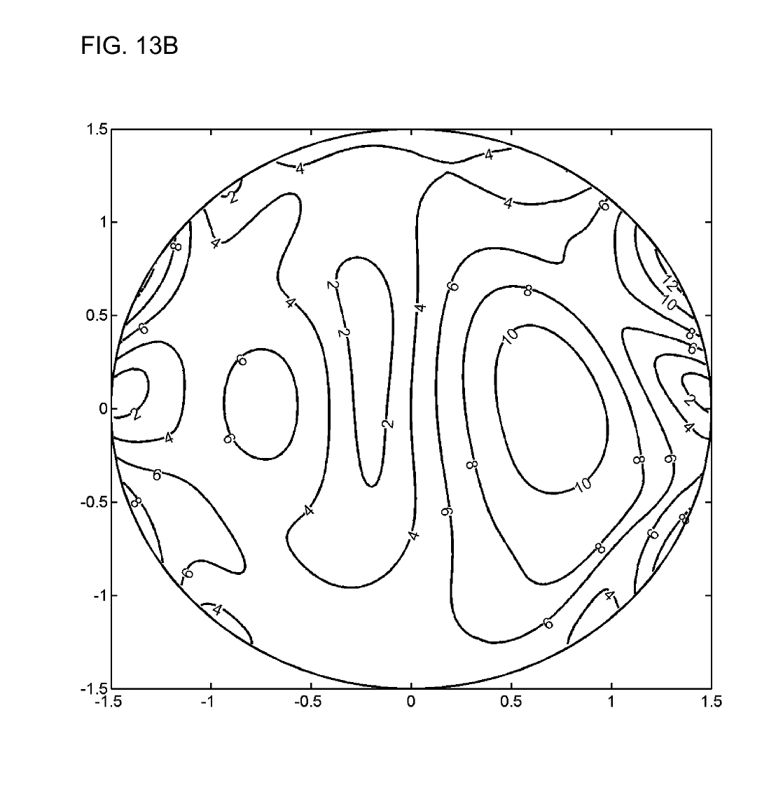

Similarly FIGS. 12a-c show the height profiles (in μm) of the subelements of a polarization correction element used for IBR compensation of the [110] lens shown in FIG. 9b, where Table 8 contains the corresponding Zernike coefficients in accordance with the foregoing description. FIGS. 13a and 13b show the residual polarization obtained by that polarization correction element for the field center (FIG. 13a) and the residual retardation obtained for the field edge FIG. 13b). While an optimum compensation is still obtained in FIG. 13a for the field center, the residual retardation for the field edge is only still a maximum of 12 nm.

Although the disclosure has been described certain embodiments, numerous variations and alternative embodiments will be apparent to one man skilled in the art, for example by combination and/or exchange of features of individual embodiments. Accordingly, it will be appreciated that such variations and alternative embodiments are also embraced by the present disclosure and the scope of the disclosure is limited only in the sense of the accompanying claims and equivalents thereof.

TABLE 1
(DESIGN DATA for FIG. 1):
(NA = 1.55; field size 26 mm * 5.5 mm; wavelength 193 nm)

| | | | | | REFRACTIVE | HALF |
|---|---|---|---|---|---|---|
| SURFACE | RADIUS | | THICKNESS | MATERIAL | INDEX | DIAMETER |
| 0 | 0.000000 | | 29.999023 | | 1.00000000 | 63.700 |
| 1 | 0.000000 | | −0.293904 | | 1.00000000 | 76.311 |
| 2 | 116.967388 | AS | 33.971623 | SIO2V | 1.56078570 | 93.710 |
| 3 | 268.858710 | | 45.405733 | | 1.00000000 | 92.342 |
| 4 | −252.724978 | AS | 58.607153 | SIO2V | 1.56078570 | 92.157 |
| 5 | −152.905212 | | 0.986967 | | 1.00000000 | 102.264 |
| 6 | 100.588881 | | 94.936165 | SIO2V | 1.56078570 | 89.748 |
| 7 | 480.541211 | AS | 22.683526 | | 1.00000000 | 61.038 |
| 8 | −151.461922 | | 9.967307 | SIO2V | 1.56078570 | 58.676 |
| 9 | −1104.178549 | AS | 2.998283 | | 1.00000000 | 54.598 |
| 10 | 0.000000 | | 0.000000 | | 1.00000000 | 53.972 |
| 11 | 0.000000 | | 26.000000 | | 1.00000000 | 53.972 |
| 12 | −4615.634680 | | 9.983258 | SIO2V | 1.56078570 | 77.043 |
| 13 | −7648.187834 | | 9.234701 | | 1.00000000 | 82.010 |
| 14 | −625.750713 | | 48.866298 | SIO2V | 1.56078570 | 85.509 |
| 15 | −110.073136 | AS | 47.938753 | | 1.00000000 | 90.434 |
| 16 | 693.459276 | | 15.566986 | SIO2V | 1.56078570 | 114.997 |
| 17 | 2225.036283 | | 111.995402 | | 1.00000000 | 115.765 |
| 18 | −209.012550 | | 24.611839 | SIO2V | 1.56078570 | 126.681 |
| 19 | −181.333947 | AS | 37.469604 | | 1.00000000 | 129.924 |
| 20 | 0.000000 | | 238.315935 | | 1.00000000 | 129.948 |
| 21 | −214.798316 | AS | −238.315935 | REFL | 1.00000000 | 151.231 |
| 22 | 186.831531 | AS | 238.315935 | REFL | 1.00000000 | 153.712 |
| 23 | 0.000000 | | 37.462671 | | 1.00000000 | 111.274 |
| 24 | 297.174670 | | 29.574318 | SIO2V | 1.56078570 | 123.808 |
| 25 | 1191.420870 | | 35.484494 | | 1.00000000 | 123.384 |
| 26 | 4081.914442 | | 22.323161 | SIO2V | 1.56078570 | 122.901 |
| 27 | 273.503277 | AS | 0.998916 | | 1.00000000 | 122.715 |
| 28 | 231.074591 | AS | 9.994721 | SIO2V | 1.56078570 | 108.656 |
| 29 | 162.434674 | | 7.329878 | | 1.00000000 | 100.728 |
| 30 | 173.924185 | | 9.996236 | SIO2V | 1.56078570 | 100.278 |
| 31 | 147.324038 | | 39.865421 | | 1.00000000 | 96.038 |
| 32 | 517.833939 | AS | 9.994259 | SIO2V | 1.56078570 | 95.918 |
| 33 | 418.975568 | | 18.691694 | | 1.00000000 | 97.853 |
| 34 | 402.609022 | | 9.991838 | SIO2V | 1.56078570 | 103.816 |
| 35 | 225.169608 | AS | 18.474719 | | 1.00000000 | 105.756 |
| 36 | 350.705440 | AS | 25.452147 | SIO2V | 1.56078570 | 107.818 |
| 37 | −3388.791523 | | 12.488356 | | 1.00000000 | 110.250 |
| 38 | 1008.270218 | AS | 41.022442 | SIO2V | 1.56078570 | 119.521 |
| 39 | −314.632041 | | 3.943706 | | 1.00000000 | 121.832 |
| 40 | 1442.963243 | AS | 12.476333 | SIO2V | 1.56078570 | 126.022 |
| 41 | −1002.829857 | | 14.096377 | | 1.00000000 | 126.891 |
| 42 | 194.591039 | | 81.128704 | SIO2V | 1.56078570 | 132.890 |
| 43 | −264.895277 | AS | −22.880987 | | 1.00000000 | 131.108 |
| 44 | 0.000000 | | −0.362185 | | 1.00000000 | 132.343 |
| 45 | 0.000000 | | 24.001275 | | 1.00000000 | 132.533 |
| 46 | 159.644367 | | 50.327970 | SIO2V | 1.56078570 | 109.736 |
| 47 | 494.742901 | AS | 0.961215 | | 1.00000000 | 105.155 |
| 48 | 328.066727 | | 14.868291 | SIO2V | 1.56078570 | 92.427 |
| 49 | −3072.231603 | AS | 0.927658 | | 1.00000000 | 86.384 |
| 50 | 84.317525 | | 69.022697 | LuAG | 2.15000000 | 64.842 |
| 51 | 0.000000 | | 3.100000 | HINDLIQ | 1.65002317 | 24.540 |
| 52 | 0.000000 | | 0.000000 | | | 15.928 |

TABLE 2
(ASPHERIC CONSTANTS for FIG. 1):

| | Surface | | | | |
|---|---|---|---|---|---|
| | 2 | 4 | 7 | 9 | 15 |
| K | 0 | 0 | 0 | 0 | 0 |
| C1 | −4.353148e−08 | −9.800573e−08 | 2.666231e−07 | 1.295769e−07 | 1.774606e−08 |
| C2 | −1.948518e−13 | 5.499401e−13 | −1.471516e−11 | 1.032347e−11 | 1.042043e−13 |
| C3 | −3.477204e−16 | −1.499103e−16 | −1.385474e−15 | 5.718200e−15 | 2.794961e−17 |
| C4 | 2.346643e−20 | −1.967686e−20 | 2.138176e−18 | −4.988183e−18 | −3.892158e−21 |
| C5 | −2.078112e−24 | 4.517642e−24 | −1.482225e−22 | 1.949505e−21 | 4.464755e−25 |
| C6 | −8.347999e−31 | −2.738209e−28 | −8.304062e−27 | −2.335999e−25 | 4.773462e−30 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |
| | Surface | | | | |
| | 19 | 21 | 22 | 27 | 28 |
| K | 0 | −2.01691 | −1.35588 | 0 | 0 |
| C1 | −1.294881e−08 | −1.791441e−08 | 1.799581e−08 | −2.305522e−07 | −5.364751e−08 |
| C2 | 2.960445e−14 | 1.393731e−13 | 6.604119e−14 | −2.977863e−12 | 2.985313e−12 |
| C3 | −3.744673e−18 | −1.959652e−18 | 1.091967e−18 | 1.067601e−15 | 1.185542e−16 |
| C4 | 3.872183e−22 | 3.972150e−23 | 3.177716e−23 | −7.036742e−20 | −5.029250e−20 |
| C5 | −1.724706e−26 | −6.577183e−28 | −5.281159e−28 | 2.314154e−24 | 3.896020e−24 |
| C6 | 4.346424e−31 | 6.141114e−33 | 1.575655e−32 | −3.151486e−29 | −1.479810e−28 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |
| | Surface | | | | |
| | 32 | 35 | 36 | 38 | 40 |
| K | 0 | 0 | 0 | 0 | 0 |
| C1 | 2.753990e−08 | 1.438723e−07 | 4.030346e−08 | 4.491651e−08 | −9.637167e−08 |
| C2 | −2.426854e−11 | −2.226044e−11 | −6.610222e−12 | −5.791619e−12 | 3.256893e−12 |
| C3 | 1.360579e−15 | 1.482620e−15 | 2.501723e−16 | 5.024169e−16 | −9.241857e−17 |
| C4 | −1.150640e−19 | −5.040252e−20 | −2.574681e−21 | −3.768862e−20 | 9.112235e−21 |
| C5 | 7.525459e−24 | 1.831772e−24 | −7.619628e−25 | 1.711080e−24 | 9.519978e−26 |
| C6 | −2.203312e−30 | −8.726413e−29 | 1.815817e−29 | −3.990765e−29 | −1.423818e−29 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |

| | Surface | | |
|---|---|---|---|
| | 43 | 47 | 49 |
| K | 0 | 0 | 0 |
| C1 | 5.213696e−08 | −1.687244e−07 | 1.276858e−07 |
| C2 | −2.852489e−13 | 1.277072e−11 | 1.143276e−12 |
| C3 | 6.349974e−17 | −5.376139e−16 | −2.525252e−16 |
| C4 | −4.223029e−21 | 1.564911e−20 | 9.197266e−20 |
| C5 | 1.155960e−25 | −3.759137e−25 | −8.401499e−24 |
| C6 | −1.415349e−30 | 1.266337e−29 | 6.171793e−28 |
| C7 | 0.000000e+00 | 0.000000e+00 | 0.000000e+00 |
| C8 | 0.000000e+00 | 0.000000e+00 | 0.000000e+00 |
| C9 | 0.000000e+00 | 0.000000e+00 | 0.000000e+00 |

TABLE 3
(DESIGN DATA for FIG. 3):

| | | | | | REFRACTIVE | HALF |
|---|---|---|---|---|---|---|
| SURFACE | RADIUS | | THICKNESS | MATERIAL | INDEX | DIAMETER |
| 0 | 0.000000 | | 56.505360 | | 1.00000000 | 61.600 |
| 1 | 0.000000 | | 0.628593 | | 1.00000000 | 84.411 |
| 2 | 0.000000 | | 9.999465 | SIO2V | 1.56078570 | 84.665 |
| 3 | 0.000000 | | 1.018383 | | 1.00000000 | 87.136 |
| 4 | 267.687560 | | 23.051668 | SIO2V | 1.56078570 | 94.506 |
| 5 | 2076.339784 | | 3.011269 | | 1.00000000 | 95.214 |
| 6 | 195.468828 | | 118.243767 | SIO2V | 1.56078570 | 99.907 |
| 7 | 213.465552 | | 65.301393 | | 1.00000000 | 87.739 |
| 8 | 233.154018 | | 24.923341 | SIO2V | 1.56078570 | 92.865 |
| 9 | −1992.179958 | AS | 1.169743 | | 1.00000000 | 91.232 |
| 10 | 397.921478 | | 69.915906 | SIO2V | 1.56078570 | 91.709 |
| 11 | 505.661172 | | 17.194249 | | 1.00000000 | 95.812 |
| 12 | −735.689494 | | 9.999732 | SIO2V | 1.56078570 | 96.173 |
| 13 | 887.983169 | | 8.242783 | | 1.00000000 | 100.163 |
| 14 | 0.000000 | | 0.000000 | | 1.00000000 | 101.571 |
| 15 | 0.000000 | | 42.782393 | | 1.00000000 | 101.571 |
| 16 | −410.552179 | AS | 78.848881 | SIO2V | 1.56078570 | 128.012 |
| 17 | −163.270786 | | 336.654237 | | 1.00000000 | 134.938 |
| 18 | 237.665945 | | 66.291266 | SIO2V | 1.56078570 | 153.690 |
| 19 | −1317.124240 | AS | 86.415659 | | 1.00000000 | 152.243 |
| 20 | 222.206724 | | 27.565105 | SIO2V | 1.56078570 | 112.997 |
| 21 | 921.104852 | AS | 68.984477 | | 1.00000000 | 110.393 |
| 22 | 0.000000 | | 0.000000 | | 1.00000000 | 82.262 |
| 23 | 0.000000 | | −223.984401 | REFL | 1.00000000 | 82.262 |
| 24 | 112.393927 | AS | −9.995120 | SIO2V | 1.56078570 | 93.383 |
| 25 | 618.177768 | | −30.194887 | | 1.00000000 | 110.198 |
| 26 | 180.843143 | | −9.993434 | SIO2V | 1.56078570 | 111.320 |
| 27 | 459.728303 | | −49.418013 | | 1.00000000 | 131.268 |
| 28 | 166.364160 | | 49.418013 | REFL | 1.00000000 | 133.173 |
| 29 | 459.728303 | | 9.993434 | SIO2V | 1.56078570 | 130.248 |
| 30 | 180.843143 | | 30.194887 | | 1.00000000 | 106.184 |
| 31 | 618.177768 | | 9.995120 | SIO2V | 1.56078570 | 102.211 |
| 32 | 112.393927 | AS | 223.984401 | | 1.00000000 | 87.128 |
| 33 | 0.000000 | | 0.000000 | | 1.00000000 | 69.972 |
| 34 | 0.000000 | | −63.976352 | REFL | 1.00000000 | 69.972 |
| 35 | 412.103957 | | −20.679211 | SIO2V | 1.56078570 | 92.437 |
| 36 | 203.153828 | | −0.998595 | | 1.00000000 | 95.263 |
| 37 | −1996.505583 | | −25.026685 | SIO2V | 1.56078570 | 104.114 |
| 38 | 387.517974 | | −0.999117 | | 1.00000000 | 105.544 |
| 39 | −217.409028 | | −35.834400 | SIO2V | 1.56078570 | 112.665 |
| 40 | −1732.046627 | | −89.753105 | | 1.00000000 | 111.738 |
| 41 | −432.227186 | | −24.454670 | SIO2V | 1.56078570 | 100.002 |
| 42 | −429.393785 | AS | −61.820584 | | 1.00000000 | 96.269 |
| 43 | 127.267221 | AS | −9.998963 | SIO2V | 1.56078570 | 96.639 |
| 44 | −354.132669 | | −7.868044 | | 1.00000000 | 110.880 |
| 45 | −523.720649 | | −14.975470 | SIO2V | 1.56078570 | 112.701 |
| 46 | −341.520890 | AS | −0.997791 | | 1.00000000 | 118.281 |
| 47 | −411.353502 | | −48.777625 | SIO2V | 1.56078570 | 120.957 |
| 48 | 342.083102 | | −8.810353 | | 1.00000000 | 122.794 |
| 49 | 514.961229 | AS | −14.987375 | SIO2V | 1.56078570 | 123.090 |
| 50 | 291.403757 | | −79.216652 | | 1.00000000 | 128.222 |
| 51 | 826.480933 | AS | −24.931069 | SIO2V | 1.56078570 | 151.976 |
| 52 | 388.289534 | | −1.073107 | | 1.00000000 | 155.772 |
| 53 | 1460.275628 | | −24.262791 | SIO2V | 1.56078570 | 162.233 |
| 54 | 543.277065 | | −0.999651 | | 1.00000000 | 163.887 |
| 55 | −4320.460965 | | −27.112870 | SIO2V | 1.56078570 | 168.245 |
| 56 | 901.554468 | | −0.999423 | | 1.00000000 | 168.871 |
| 57 | −227.624376 | | −78.149238 | SIO2V | 1.56078570 | 170.522 |
| 58 | −2243.544699 | | −9.897025 | | 1.00000000 | 167.855 |
| 59 | 0.000000 | | 0.000000 | | 1.00000000 | 165.919 |
| 60 | 0.000000 | | −43.822974 | | 1.00000000 | 165.919 |
| 61 | −193.437748 | | −56.826827 | SIO2V | 1.56078570 | 128.975 |
| 62 | 4852.914186 | AS | −1.258966 | | 1.00000000 | 124.642 |
| 63 | −126.542916 | | −25.022273 | SIO2V | 1.56078570 | 89.797 |
| 64 | −202.284936 | AS | −0.996510 | | 1.00000000 | 78.587 |
| 65 | −95.520347 | | −72.724717 | LUAG | 2.10000000 | 70.909 |
| 66 | 0.000000 | | −6.000000 | HIINDLIQ | 1.64000000 | 28.915 |
| 67 | 0.000000 | | 0.000000 | | | 15.401 |

TABLE 4
(ASPHERIC CONSTANTS for FIG. 3):

| | Surface | | | | |
|---|---|---|---|---|---|
| | 9 | 16 | 19 | 21 | 24 |
| K | 0 | 0 | 0 | 0 | 0 |
| C1 | 1.993155e−07 | 7.648792e−08 | 1.310449e−08 | 1.499407e−08 | −1.140413e−07 |
| C2 | −2.965837e−11 | −1.147476e−12 | −1.473288e−13 | 4.898569e−13 | −1.405657e−12 |
| C3 | 7.084938e−15 | −1.620016e−16 | 1.789597e−18 | −4.831673e−18 | −6.422308e−16 |
| C4 | −1.108567e−18 | 1.291519e−20 | −3.347563e−23 | 5.603761e−22 | 9.595133e−20 |
| C5 | 1.294384e−22 | −4.536509e−25 | 7.855804e−28 | 1.107164e−28 | −1.651690e−23 |
| C6 | −8.666805e−27 | 8.063130e−30 | −1.561895e−32 | −1.720748e−31 | 1.285598e−27 |
| C7 | 2.821071e−31 | −5.992411e−35 | 1.565488e−37 | 3.402783e−35 | −5.054656e−32 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |
| | Surface | | | | |
| | 32 | 42 | 43 | 46 | 49 |
| K | 0 | 0 | 0 | 0 | 0 |
| C1 | −1.140413e−07 | −4.189168e−08 | −1.685701e−07 | 6.336319e−09 | 5.280703e−08 |
| C2 | −1.405657e−12 | −3.147936e−13 | 9.635698e−12 | 4.071242e−12 | 1.157060e−12 |
| C3 | −6.422308e−16 | −1.294082e−18 | −1.217963e−15 | −3.577670e−16 | −7.824880e−17 |
| C4 | 9.595133e−20 | −2.828644e−22 | 1.012583e−19 | 2.732048e−20 | 7.171704e−21 |
| C5 | −1.651690e−23 | 4.489648e−26 | −8.858422e−24 | −1.655966e−24 | −3.888551e−26 |
| C6 | 1.285598e−27 | −1.468171e−29 | 4.866371e−28 | 6.535740e−29 | −2.007284e−29 |
| C7 | −5.054656e−32 | 1.147294e−33 | −1.337836e−32 | −1.353076e−33 | 4.237726e−34 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |

| Surface | | | |
|---|---|---|---|
| | 51 | 62 | 64 |
| K | 0 | 0 | 0 |
| C1 | −6.339317e−09 | 4.857833e−08 | −2.139384e−07 |
| C2 | 9.839286e−13 | −8.830803e−12 | 1.525695e−11 |
| C3 | −3.557535e−17 | 7.521403e−16 | −4.799207e−15 |
| C4 | 2.050828e−21 | −4.932093e−20 | 1.286852e−18 |
| C5 | −7.703006e−26 | 2.223792e−24 | −3.670356e−22 |
| C6 | 2.045013e−30 | −5.700404e−29 | 7.133596e−26 |
| C7 | −2.770838e−35 | −3.566708e−35 | −9.239454e−30 |
| C8 | 0.000000e+00 | 4.807714e−38 | 6.969720e−34 |
| C9 | 0.000000e+00 | −1.056980e−42 | −2.499170e−38 |

TABLE 5
Zernike coefficients for FIG. 1 with [100] lens:

| Zernike | Element 1 | Element 2 | Element 3 |
|---|---|---|---|
| 1 | 8.28E−02 | −3.48E−03 | 8.15E−02 |
| 2 | −1.12E−02 | 1.62E−01 | −1.16E−02 |
| 3 | 3.22E−01 | 1.50E−02 | 3.21E−01 |
| 4 | 4.08E−03 | −3.98E−03 | −3.13E−05 |
| 5 | −1.19E+01 | −1.64E−03 | −1.19E+01 |
| 6 | 1.48E−02 | −5.22E+00 | 1.47E−02 |
| 7 | 1.53E−03 | 4.36E−03 | 1.00E−03 |
| 8 | 1.65E−01 | −2.19E−03 | 1.29E−01 |
| 9 | 1.58E−02 | 2.05E−03 | 8.85E−03 |
| 10 | 1.43E−02 | 5.89E−02 | 1.38E−02 |
| 11 | −4.02E−01 | 2.37E−02 | −3.74E−01 |
| 12 | 3.61E+00 | 9.78E−05 | 3.54E+00 |
| 13 | −1.11E−02 | 3.62E+00 | −1.12E−02 |
| 14 | 4.76E−03 | −8.69E−02 | 4.05E−03 |
| 15 | 8.91E−02 | −5.32E−03 | 5.26E−02 |
| 16 | 2.96E−02 | 1.58E−03 | 1.98E−02 |
| 17 | −1.37E−02 | 1.56E−02 | −2.85E−02 |
| 18 | −3.63E−03 | −4.99E−02 | −3.67E−03 |
| 19 | −9.41E−03 | −3.82E−03 | −1.04E−02 |
| 20 | −8.93E−02 | −1.38E−02 | −6.41E−02 |
| 21 | 6.83E−01 | 8.84E−05 | 5.92E−01 |
| 22 | 2.80E−04 | −7.95E−01 | 1.24E−05 |
| 23 | −1.02E−04 | −6.01E−02 | −1.04E−03 |
| 24 | 1.99E−01 | 4.05E−04 | 1.56E−01 |
| 25 | 3.86E−02 | 5.00E−04 | 2.58E−02 |
| 26 | 7.30E−03 | 1.39E−01 | 6.66E−03 |
| 27 | −5.21E−02 | −9.22E−03 | −5.42E−02 |
| 28 | 3.64E−02 | −7.62E−03 | 1.65E−02 |
| 29 | 2.39E−03 | 3.00E−02 | 2.45E−03 |
| 30 | −1.57E−04 | 1.53E−01 | −1.37E−03 |
| 31 | −2.10E−01 | 1.63E−03 | −1.81E−01 |
| 32 | 5.43E−01 | 1.08E−04 | 4.37E−01 |
| 33 | −3.73E−04 | 3.08E−01 | −6.85E−04 |
| 34 | 4.18E−04 | −7.80E−02 | −6.80E−04 |
| 35 | 2.37E−01 | −1.77E−03 | 1.89E−01 |
| 36 | 4.47E−02 | 1.06E−03 | 2.88E−02 |
| 37 | 6.12E−01 | 3.30E−04 | 6.10E−01 |
| 38 | −6.88E−03 | 2.32E+00 | −7.15E−03 |
| 39 | −6.13E−03 | −9.59E−02 | −7.05E−03 |
| 40 | 4.76E−02 | 6.55E−03 | 4.83E−02 |
| 41 | 4.20E−02 | −1.60E−03 | 1.70E−02 |
| 42 | −4.14E−04 | 4.15E−03 | −4.74E−04 |
| 43 | −2.68E−04 | 4.10E−02 | −1.70E−03 |
| 44 | −2.32E−01 | −2.25E−03 | −2.01E−01 |
| 45 | 6.83E−01 | 3.67E−04 | 5.68E−01 |
| 46 | −9.34E−04 | 2.81E−01 | −1.27E−03 |
| 47 | 7.97E−04 | −9.23E−02 | −4.25E−04 |
| 48 | 2.45E−01 | −1.38E−03 | 1.97E−01 |
| 49 | 5.38E−02 | 9.61E−04 | 3.49E−02 |
| 50 | −7.00E−03 | −2.09E−01 | −7.84E−03 |
| 51 | 5.02E−02 | −1.02E−02 | 3.60E−02 |
| 52 | −9.15E−01 | −1.47E−04 | −9.20E−01 |
| 53 | 8.34E−03 | −2.09E+00 | 8.02E−03 |
| 54 | 4.16E−04 | 6.56E−02 | −6.87E−04 |
| 55 | −3.27E−02 | 6.41E−04 | −3.93E−02 |
| 56 | 4.80E−02 | −1.64E−03 | 1.91E−02 |
| 57 | 3.82E−04 | 7.56E−03 | 3.41E−04 |
| 58 | −8.37E−04 | 6.39E−02 | −2.40E−03 |
| 59 | −2.43E−01 | −2.07E−03 | −2.14E−01 |
| 60 | 7.38E−01 | 3.59E−04 | 6.21E−01 |
| 61 | −1.01E−03 | 1.48E−01 | −1.37E−03 |
| 62 | 8.11E−04 | −9.84E−02 | −4.80E−04 |
| 63 | 2.57E−01 | −1.20E−03 | 2.12E−01 |
| 64 | 6.27E−02 | 9.17E−04 | 4.10E−02 |
| 65 | 5.29E−03 | −4.88E−03 | −9.60E−03 |
| 66 | 2.19E−03 | 2.67E−02 | 1.29E−03 |
| 67 | 7.61E−03 | 7.87E−02 | 6.75E−03 |
| 68 | −3.80E−02 | 9.28E−03 | −4.76E−02 |
| 69 | 4.11E−01 | −3.66E−04 | 4.02E−01 |
| 70 | −2.97E−03 | 6.57E−01 | −3.24E−03 |
| 71 | 4.34E−04 | 2.99E−02 | −7.66E−04 |
| 72 | −1.37E−02 | 2.47E−04 | −1.92E−02 |
| 73 | 5.73E−02 | −1.79E−03 | 2.55E−02 |
| 74 | 3.79E−04 | 1.46E−02 | 3.16E−04 |
| 75 | −9.06E−04 | 7.68E−02 | −2.54E−03 |
| 76 | −2.51E−01 | −1.72E−03 | −2.27E−01 |
| 77 | 7.47E−01 | 3.78E−04 | 6.34E−01 |
| 78 | −9.70E−04 | 1.98E−01 | −1.32E−03 |
| 79 | 7.88E−04 | −9.81E−02 | −5.24E−04 |
| 80 | 2.55E−01 | −1.31E−03 | 2.17E−01 |
| 81 | 7.13E−02 | 9.31E−04 | 4.71E−02 |
| 82 | −2.47E−03 | −4.91E−02 | −4.14E−03 |
| 83 | 3.09E−02 | 8.09E−04 | 3.79E−02 |
| 84 | −1.89E−02 | 4.93E−03 | −3.54E−02 |
| 85 | −2.05E−03 | −3.05E−02 | −3.11E−03 |
| 86 | −2.42E−03 | −6.97E−02 | −3.48E−03 |
| 87 | 3.88E−02 | −1.76E−03 | 2.53E−02 |
| 88 | −1.16E−01 | −3.49E−04 | −1.24E−01 |
| 89 | 9.09E−04 | −2.37E−01 | 5.50E−04 |
| 90 | −5.29E−04 | 3.01E−02 | −1.82E−03 |
| 91 | −6.03E−03 | 8.78E−04 | −1.50E−02 |
| 92 | 6.45E−02 | −1.69E−03 | 3.08E−02 |
| 93 | 2.82E−04 | 1.48E−02 | 1.95E−04 |
| 94 | −8.48E−04 | 6.89E−02 | −2.47E−03 |
| 95 | −2.44E−01 | −1.88E−03 | −2.27E−01 |
| 96 | 7.69E−01 | 3.82E−04 | 6.69E−01 |
| 97 | −9.48E−04 | 2.10E−01 | −1.27E−03 |
| 98 | 7.56E−04 | −9.46E−02 | −5.20E−04 |
| 99 | 2.40E−01 | −1.28E−03 | 2.12E−01 |
| 100 | 7.96E−02 | 8.77E−04 | 5.34E−02 |

TABLE 6
Zernike coefficients for FIG. 1 with [110] lens:

| Zernike | Element 1 | Element 2 | Element 3 |
|---|---|---|---|
| 1 | 1.23E+00 | 7.07E−03 | 1.23E+00 |
| 2 | 1.51E−02 | 3.33E−01 | 1.50E−02 |
| 3 | −3.38E−01 | −2.41E−02 | −3.41E−01 |
| 4 | −6.89E+00 | 6.38E−03 | −6.91E+00 |
| 5 | −1.71E+00 | 1.19E−03 | −1.71E+00 |
| 6 | −1.67E−02 | 6.23E+00 | −1.66E−02 |
| 7 | −5.77E−04 | 8.01E−02 | −4.05E−04 |
| 8 | −3.40E−01 | −6.04E−04 | −3.11E−01 |
| 9 | 1.12E+00 | −2.82E−03 | 1.08E+00 |
| 10 | −1.20E−02 | 1.14E−01 | −1.21E−02 |
| 11 | −3.64E−01 | −3.74E−02 | −3.63E−01 |
| 12 | −6.80E−01 | 4.97E−04 | −7.01E−01 |
| 13 | 1.18E−02 | −3.47E+00 | 1.15E−02 |
| 14 | −1.12E−02 | −1.59E−01 | −1.10E−02 |
| 15 | −2.66E−02 | 1.27E−02 | 1.93E−03 |
| 16 | 7.67E−01 | −3.42E−03 | 7.17E−01 |
| 17 | 3.27E+00 | −1.44E−02 | 3.29E+00 |
| 18 | 2.25E−03 | 2.15E+00 | 2.41E−03 |
| 19 | 1.04E−02 | 2.14E−02 | 1.02E−02 |
| 20 | −1.53E−01 | 1.86E−02 | −1.34E−01 |
| 21 | 2.99E−01 | −1.18E−04 | 2.68E−01 |
| 22 | 7.32E−03 | −1.98E+00 | 7.10E−03 |
| 23 | −1.36E−03 | 4.31E−03 | −1.31E−03 |
| 24 | −5.88E−02 | 1.53E−03 | −2.90E−02 |
| 25 | 6.73E−01 | 1.02E−04 | 6.19E−01 |
| 26 | −6.31E−03 | 2.36E−01 | −6.29E−03 |
| 27 | 1.68E−02 | −1.50E−02 | −1.09E−02 |
| 28 | −2.91E−01 | 8.19E−03 | −2.56E−01 |
| 29 | 5.01E−04 | −1.26E+00 | 4.32E−04 |
| 30 | 2.47E−03 | −4.86E−02 | 2.46E−03 |
| 31 | 5.65E−03 | 7.46E−03 | 2.64E−02 |
| 32 | 4.69E−01 | 2.57E−04 | 4.35E−01 |
| 33 | −4.78E−03 | 1.21E+00 | −4.78E−03 |
| 34 | 4.70E−03 | 1.89E−01 | 4.78E−03 |
| 35 | −1.64E−01 | −2.44E−03 | −1.36E−01 |
| 36 | 1.10E−01 | 1.82E−04 | 5.24E−02 |
| 37 | 1.10E+00 | −4.48E−03 | 1.10E+00 |
| 38 | 3.80E−03 | 9.45E−01 | 3.89E−03 |
| 39 | 8.83E−03 | 4.43E−02 | 8.72E−03 |
| 40 | 4.85E−02 | 4.99E−03 | 2.12E−02 |
| 41 | −1.01E+00 | 1.56E−03 | −9.75E−01 |
| 42 | −9.55E−04 | −1.55E−01 | −9.21E−04 |
| 43 | −3.48E−03 | −9.44E−02 | −3.51E−03 |
| 44 | −8.20E−02 | −4.91E−03 | −6.76E−02 |
| 45 | 1.83E−01 | 4.28E−04 | 1.46E−01 |
| 46 | −2.21E−03 | 2.08E−01 | −2.29E−03 |
| 47 | 4.48E−04 | 7.32E−02 | 6.45E−04 |
| 48 | −2.40E−01 | 1.43E−03 | −2.10E−01 |
| 49 | 1.54E−01 | −8.40E−04 | 9.17E−02 |
| 50 | 3.42E−04 | 1.70E−01 | 4.41E−04 |
| 51 | 2.23E−03 | −1.11E−02 | −8.28E−03 |
| 52 | −3.83E−01 | 2.41E−03 | −3.77E−01 |
| 53 | −3.97E−03 | −1.09E−01 | −3.90E−03 |
| 54 | −2.13E−03 | −1.04E−01 | −2.08E−03 |
| 55 | 1.09E−01 | 1.24E−03 | 8.29E−02 |
| 56 | −4.97E−02 | −1.62E−03 | −1.63E−02 |
| 57 | −1.52E−03 | 3.20E−01 | −1.41E−03 |
| 58 | −9.75E−05 | −3.73E−02 | −2.30E−04 |
| 59 | −2.32E−01 | 7.66E−05 | −2.19E−01 |
| 60 | 8.14E−02 | 3.06E−04 | 4.00E−02 |
| 61 | 2.64E−03 | −4.45E−01 | 2.42E−03 |
| 62 | −3.50E−03 | 1.32E−02 | −3.29E−03 |
| 63 | −1.91E−01 | 2.70E−03 | −1.65E−01 |
| 64 | 4.63E−01 | −1.03E−03 | 4.03E−01 |
| 65 | 3.09E−01 | −2.72E−03 | 3.00E−01 |
| 66 | −7.11E−04 | 1.42E+00 | −7.17E−04 |
| 67 | 8.68E−04 | 1.23E−02 | 8.75E−04 |
| 68 | −5.05E−02 | 8.70E−04 | −5.85E−02 |
| 69 | −4.86E−01 | −4.72E−04 | −4.82E−01 |
| 70 | 2.16E−03 | −4.33E−01 | 2.18E−03 |
| 71 | −4.26E−03 | −8.66E−02 | −4.26E−03 |
| 72 | 1.07E−01 | −8.27E−04 | 7.51E−02 |
| 73 | 1.86E−01 | 3.73E−04 | 2.23E−01 |
| 74 | −7.72E−05 | −1.07E−01 | −3.66E−05 |
| 75 | 2.02E−03 | −2.59E−02 | 1.91E−03 |
| 76 | −1.94E−01 | 3.12E−03 | −1.82E−01 |
| 77 | 2.46E−01 | 1.31E−04 | 2.02E−01 |
| 78 | 2.75E−03 | −3.73E−01 | 2.59E−03 |
| 79 | −2.22E−03 | 4.60E−02 | −2.10E−03 |
| 80 | −1.25E−01 | 2.12E−03 | −1.08E−01 |
| 81 | 5.09E−01 | −8.99E−04 | 4.56E−01 |
| 82 | −3.15E−03 | −4.73E−02 | −3.14E−03 |
| 83 | −2.38E−02 | −8.56E−03 | −1.34E−02 |
| 84 | 5.25E−02 | 5.96E−04 | 4.59E−02 |
| 85 | −7.38E−04 | −2.87E−01 | −7.86E−04 |
| 86 | −3.16E−05 | −2.48E−02 | 4.81E−05 |
| 87 | 5.58E−02 | 2.82E−03 | 5.17E−02 |
| 88 | 1.95E−01 | −8.12E−04 | 1.99E−01 |
| 89 | 6.58E−04 | −5.77E−02 | 7.71E−04 |
| 90 | 1.62E−03 | −1.03E−02 | 1.51E−03 |
| 91 | 7.50E−02 | 1.40E−04 | 4.29E−02 |
| 92 | −2.87E−01 | 1.00E−03 | −2.51E−01 |
| 93 | 7.64E−04 | −2.63E−01 | 7.62E−04 |
| 94 | 9.85E−04 | −5.21E−02 | 9.45E−04 |
| 95 | −8.10E−02 | 2.64E−03 | −7.63E−02 |
| 96 | 3.40E−01 | 9.13E−05 | 2.98E−01 |
| 97 | 1.27E−04 | −1.69E−01 | 1.02E−04 |
| 98 | 3.25E−04 | 7.54E−02 | 3.96E−04 |
| 99 | −1.33E−01 | 1.66E−03 | −1.28E−01 |
| 100 | 3.68E−01 | −8.69E−04 | 3.25E−01 |

TABLE 7
Zernike coefficients for FIG. 3 with [100] lens:

| Zernike | Element 1 | Element 2 | Element 3 |
|---|---|---|---|
| 1 | −5.20E−02 | −1.98E−02 | −5.16E−02 |
| 2 | −1.15E−02 | 1.82E−01 | −1.15E−02 |
| 3 | 1.50E−01 | 1.16E−02 | 1.51E−01 |
| 4 | −1.07E−01 | −2.20E−02 | −1.06E−01 |
| 5 | −1.34E+01 | −2.71E−03 | −1.34E+01 |
| 6 | 1.41E−03 | −5.60E+00 | 1.45E−03 |
| 7 | 1.47E−03 | −2.81E−02 | 1.43E−03 |
| 8 | 1.08E−01 | −4.12E−03 | 9.92E−02 |
| 9 | −4.27E−02 | 5.85E−04 | −4.05E−02 |
| 10 | 1.41E−02 | 8.59E−02 | 1.42E−02 |
| 11 | −4.65E−01 | 2.26E−02 | −4.60E−01 |
| 12 | 4.58E+00 | −6.33E−04 | 4.57E+00 |
| 13 | −3.52E−03 | 3.65E+00 | −3.43E−03 |
| 14 | 3.28E−03 | −2.67E−02 | 3.21E−03 |
| 15 | −1.29E−03 | −3.64E−03 | −8.29E−03 |
| 16 | −2.37E−02 | 1.69E−03 | −2.09E−02 |
| 17 | −1.58E−01 | 9.09E−02 | −1.56E−01 |
| 18 | −1.67E−02 | −1.31E−01 | −1.68E−02 |
| 19 | −9.00E−03 | −9.34E−03 | −8.96E−03 |
| 20 | 3.17E−02 | −1.15E−02 | 3.42E−02 |
| 21 | −3.46E−01 | −3.18E−04 | −3.60E−01 |
| 22 | 8.48E−04 | −1.59E+00 | 9.43E−04 |
| 23 | −1.25E−03 | −3.60E−02 | −1.36E−03 |
| 24 | 1.27E−01 | 7.76E−04 | 1.17E−01 |
| 25 | −3.31E−02 | 9.62E−04 | −2.98E−02 |
| 26 | 9.70E−03 | 7.57E−02 | 9.79E−03 |
| 27 | −4.80E−02 | −3.29E−04 | −4.88E−02 |
| 28 | −3.12E−02 | −1.76E−02 | −2.89E−02 |
| 29 | 5.07E−03 | 7.34E−03 | 5.09E−03 |
| 30 | 1.77E−03 | 1.11E−01 | 1.89E−03 |
| 31 | −1.16E−01 | 4.07E−03 | −1.12E−01 |
| 32 | 8.53E−02 | 8.68E−05 | 7.06E−02 |
| 33 | −4.51E−04 | 5.63E−01 | −3.42E−04 |
| 34 | 1.74E−04 | −3.33E−02 | 5.81E−05 |
| 35 | 1.33E−01 | −2.08E−03 | 1.21E−01 |
| 36 | −3.65E−02 | 2.91E−03 | −3.29E−02 |
| 37 | 6.20E−01 | 4.55E−03 | 6.26E−01 |
| 38 | −5.12E−04 | 2.56E+00 | −5.97E−04 |
| 39 | −6.99E−03 | −4.66E−02 | −6.93E−03 |
| 40 | 2.52E−02 | 6.82E−03 | 2.53E−02 |
| 41 | −2.95E−02 | 1.05E−03 | −2.69E−02 |
| 42 | −3.08E−03 | −2.54E−02 | −3.17E−03 |
| 43 | −1.83E−04 | −1.04E−02 | −7.27E−05 |
| 44 | −1.15E−01 | −2.59E−03 | −1.11E−01 |
| 45 | 2.88E−01 | 3.57E−04 | 2.71E−01 |
| 46 | −3.54E−04 | 7.37E−02 | −2.30E−04 |
| 47 | 4.01E−04 | −4.84E−02 | 2.74E−04 |
| 48 | 1.37E−01 | −1.15E−03 | 1.24E−01 |
| 49 | −3.79E−02 | 2.15E−03 | −3.42E−02 |
| 50 | −7.02E−03 | −2.04E−01 | −7.08E−03 |
| 51 | 5.09E−02 | −9.05E−03 | 5.25E−02 |
| 52 | −1.00E+00 | −8.40E−05 | −9.93E−01 |
| 53 | 1.17E−03 | −2.40E+00 | 1.05E−03 |
| 54 | 2.77E−03 | 3.21E−02 | 2.88E−03 |
| 55 | −2.37E−02 | −4.55E−04 | −2.56E−02 |
| 56 | −2.73E−02 | −3.95E−03 | −2.44E−02 |
| 57 | 1.73E−03 | −4.84E−03 | 1.70E−03 |
| 58 | −6.60E−04 | 4.85E−02 | −5.38E−04 |
| 59 | −1.20E−01 | −1.33E−03 | −1.15E−01 |
| 60 | 2.82E−01 | 3.92E−04 | 2.62E−01 |
| 61 | −2.60E−04 | 1.81E−02 | −1.14E−04 |
| 62 | 2.84E−04 | −5.74E−02 | 1.50E−04 |
| 63 | 1.63E−01 | −1.49E−03 | 1.50E−01 |
| 64 | −4.08E−02 | 2.56E−03 | −3.74E−02 |
| 65 | 2.14E−02 | −3.63E−02 | 2.58E−02 |
| 66 | 1.53E−02 | 1.19E−01 | 1.53E−02 |
| 67 | 7.88E−03 | 1.32E−01 | 7.81E−03 |
| 68 | −4.64E−02 | 7.68E−03 | −4.27E−02 |
| 69 | 6.28E−01 | −5.30E−05 | 6.37E−01 |
| 70 | −1.17E−03 | 1.28E+00 | −1.28E−03 |
| 71 | 1.20E−04 | 1.27E−02 | 2.28E−04 |
| 72 | −1.17E−02 | 6.03E−04 | −1.24E−02 |
| 73 | −3.05E−02 | −4.10E−03 | −2.74E−02 |
| 74 | 5.12E−04 | −5.97E−03 | 4.65E−04 |
| 75 | −5.85E−04 | 5.53E−02 | −4.59E−04 |
| 76 | −1.46E−01 | −1.44E−03 | −1.42E−01 |
| 77 | 2.91E−01 | 4.82E−04 | 2.70E−01 |
| 78 | −2.85E−04 | 1.42E−01 | −1.21E−04 |
| 79 | 2.54E−04 | −5.57E−02 | 1.01E−04 |
| 80 | 1.71E−01 | −1.65E−03 | 1.57E−01 |
| 81 | −4.08E−02 | 2.91E−03 | −3.78E−02 |
| 82 | −5.64E−03 | −4.41E−02 | −5.71E−03 |
| 83 | 2.45E−03 | −4.80E−03 | 1.97E−03 |
| 84 | −5.55E−04 | 2.12E−02 | 4.58E−03 |
| 85 | −8.43E−03 | −3.86E−02 | −8.41E−03 |
| 86 | −4.36E−03 | −9.15E−02 | −4.46E−03 |
| 87 | 5.15E−02 | −4.47E−03 | 5.44E−02 |
| 88 | −3.55E−01 | −4.58E−04 | −3.45E−01 |
| 89 | 7.27E−04 | −5.43E−01 | 5.93E−04 |
| 90 | −3.63E−04 | 5.57E−03 | −2.48E−04 |
| 91 | −5.94E−03 | 1.26E−03 | −7.76E−03 |
| 92 | −3.39E−02 | −4.09E−03 | −3.06E−02 |
| 93 | 4.93E−04 | −9.61E−03 | 4.45E−04 |
| 94 | −5.44E−04 | 4.51E−02 | −4.06E−04 |
| 95 | −1.54E−01 | −1.82E−03 | −1.50E−01 |
| 96 | 3.42E−01 | 5.55E−04 | 3.20E−01 |
| 97 | −3.27E−04 | 1.19E−01 | −1.64E−04 |
| 98 | 2.87E−04 | −6.36E−02 | 1.12E−04 |
| 99 | 1.80E−01 | −1.60E−03 | 1.66E−01 |
| 100 | −3.94E−02 | 3.04E−03 | −3.71E−02 |

TABLE 8
Zernike coefficients for FIG. 3 with [110] lens:

| Zernike | Element 1 | Element 2 | Element 3 |
|---|---|---|---|
| 1 | 4.83E−01 | 2.93E−02 | 4.79E−01 |
| 2 | 1.68E−02 | 1.92E−01 | 1.67E−02 |
| 3 | −2.79E−01 | −1.85E−02 | −2.81E−01 |
| 4 | −7.03E+00 | 3.27E−02 | −7.04E+00 |
| 5 | −2.49E+00 | 1.79E−02 | −2.49E+00 |
| 6 | 1.19E−02 | 5.86E+00 | 1.15E−02 |
| 7 | −2.46E−03 | 6.03E−03 | −2.48E−03 |
| 8 | −2.78E−01 | 2.94E−03 | −2.72E−01 |
| 9 | 2.13E+00 | −6.50E−03 | 2.13E+00 |
| 10 | −7.36E−03 | 6.11E−02 | −7.31E−03 |
| 11 | −3.00E−01 | −3.06E−02 | −3.01E−01 |
| 12 | −6.65E−01 | 4.38E−03 | −6.67E−01 |
| 13 | 3.12E−03 | −4.56E+00 | 1.95E−03 |
| 14 | −1.08E−02 | −1.30E−01 | −1.08E−02 |
| 15 | 1.17E−01 | 8.74E−03 | 1.19E−01 |
| 16 | 5.53E−01 | −7.61E−03 | 5.45E−01 |
| 17 | 3.72E+00 | −4.84E−02 | 3.73E+00 |
| 18 | 5.10E−02 | 2.15E+00 | 5.14E−02 |
| 19 | 1.11E−02 | 8.31E−02 | 1.12E−02 |
| 20 | −3.69E−02 | 1.90E−02 | −3.38E−02 |
| 21 | 4.46E−01 | −1.55E−03 | 4.43E−01 |
| 22 | −3.18E−03 | −6.97E−01 | −4.58E−03 |
| 23 | 3.97E−03 | 5.38E−02 | 3.92E−03 |
| 24 | −2.50E−02 | −2.92E−03 | −2.22E−02 |
| 25 | 1.07E−01 | 5.30E−03 | 9.70E−02 |
| 26 | −5.33E−03 | 1.78E−01 | −5.35E−03 |
| 27 | 7.08E−02 | −1.94E−02 | 6.51E−02 |
| 28 | −9.66E−01 | 3.20E−02 | −9.62E−01 |
| 29 | −1.98E−02 | −1.48E+00 | −1.96E−02 |
| 30 | −1.14E−03 | −2.60E−02 | −1.04E−03 |
| 31 | 5.01E−02 | 2.29E−04 | 5.19E−02 |
| 32 | 2.07E−01 | 1.67E−03 | 2.02E−01 |
| 33 | 3.24E−03 | 1.98E+00 | 1.69E−03 |
| 34 | 5.34E−03 | 1.25E−01 | 5.24E−03 |
| 35 | −1.14E−01 | −6.94E−04 | −1.10E−01 |
| 36 | −3.41E−01 | 3.97E−04 | −3.51E−01 |
| 37 | 1.29E+00 | −8.80E−03 | 1.29E+00 |
| 38 | 3.27E−02 | 1.20E+00 | 3.41E−02 |
| 39 | 1.08E−02 | 1.17E−02 | 1.07E−02 |
| 40 | −3.49E−03 | 8.00E−03 | −7.33E−03 |
| 41 | −7.60E−01 | −3.03E−03 | −7.52E−01 |
| 42 | −5.82E−04 | 4.20E−01 | −8.98E−05 |
| 43 | −2.67E−03 | −7.35E−02 | −2.53E−03 |
| 44 | −8.45E−02 | −5.13E−03 | −8.43E−02 |
| 45 | −1.73E−01 | 1.31E−03 | −1.79E−01 |
| 46 | 4.18E−03 | −5.21E−01 | 2.16E−03 |
| 47 | −4.32E−03 | −3.76E−02 | −4.48E−03 |
| 48 | −1.04E−01 | 3.54E−03 | −9.82E−02 |
| 49 | 1.92E−01 | −4.14E−03 | 1.82E−01 |
| 50 | −7.42E−04 | 5.07E−02 | −8.61E−04 |
| 51 | 9.49E−03 | −1.09E−02 | 9.43E−03 |
| 52 | −6.69E−01 | 9.88E−03 | −6.68E−01 |
| 53 | −9.34E−03 | −3.79E−01 | −7.65E−03 |
| 54 | −6.83E−03 | −7.66E−02 | −6.92E−03 |
| 55 | 3.19E−02 | −1.12E−03 | 2.73E−02 |
| 56 | 5.60E−01 | −6.94E−03 | 5.68E−01 |
| 57 | 7.43E−03 | 3.40E−01 | 8.02E−03 |
| 58 | 3.67E−03 | 3.54E−02 | 3.86E−03 |
| 59 | −1.35E−01 | 3.56E−03 | −1.33E−01 |
| 60 | −1.47E−03 | −9.18E−04 | −7.85E−03 |
| 61 | −1.72E−03 | −5.02E−01 | −4.13E−03 |
| 62 | −4.12E−03 | 6.37E−03 | −4.32E−03 |
| 63 | −3.67E−02 | 2.06E−03 | −3.14E−02 |
| 64 | 3.71E−01 | −2.01E−03 | 3.59E−01 |
| 65 | 3.96E−01 | −1.31E−02 | 3.99E−01 |
| 66 | 1.62E−02 | 1.66E+00 | 1.55E−02 |
| 67 | 1.53E−03 | 1.38E−03 | 1.27E−03 |
| 68 | −5.96E−02 | 3.90E−03 | −5.77E−02 |
| 69 | −1.56E−01 | −5.63E−03 | −1.52E−01 |
| 70 | 2.32E−04 | −3.04E−01 | 2.23E−03 |
| 71 | −1.51E−03 | −5.28E−03 | −1.57E−03 |
| 72 | 4.45E−02 | −1.84E−03 | 3.75E−02 |
| 73 | 4.54E−02 | 4.67E−03 | 5.26E−02 |
| 74 | −3.69E−03 | −3.03E−01 | −3.14E−03 |
| 75 | 2.66E−03 | −2.61E−03 | 2.93E−03 |
| 76 | −2.91E−02 | 2.51E−03 | −2.63E−02 |
| 77 | 2.11E−01 | −6.93E−04 | 2.03E−01 |
| 78 | −6.88E−04 | 9.83E−02 | −3.22E−03 |
| 79 | 1.83E−03 | 6.74E−02 | 1.56E−03 |
| 80 | −5.99E−02 | 1.58E−03 | −5.59E−02 |
| 81 | 8.73E−02 | −1.09E−03 | 7.31E−02 |
| 82 | −4.97E−03 | −9.09E−02 | −4.70E−03 |
| 83 | −8.53E−03 | −9.63E−03 | −4.26E−03 |
| 84 | −5.39E−02 | 4.49E−03 | −5.13E−02 |
| 85 | 7.83E−04 | −6.40E−01 | −1.20E−04 |
| 86 | −3.20E−03 | −5.82E−04 | −3.52E−03 |
| 87 | 4.35E−02 | 1.13E−03 | 4.60E−02 |
| 88 | 4.54E−01 | −1.08E−03 | 4.57E−01 |
| 89 | 9.66E−04 | 2.35E−01 | 3.33E−03 |
| 90 | 6.07E−03 | 3.56E−02 | 6.01E−03 |
| 91 | 1.33E−02 | 5.63E−04 | 6.51E−03 |
| 92 | −5.06E−01 | 2.07E−03 | −4.97E−01 |
| 93 | −4.84E−03 | −8.16E−02 | −4.19E−03 |
| 94 | 2.11E−05 | −3.62E−02 | 4.06E−04 |
| 95 | −2.61E−02 | 7.66E−04 | −2.55E−02 |
| 96 | 9.27E−02 | 1.12E−04 | 8.33E−02 |
| 97 | 3.17E−03 | 9.43E−02 | 5.00E−04 |
| 98 | 1.19E−03 | 4.57E−02 | 7.97E−04 |
| 99 | −1.26E−01 | 2.23E−03 | −1.22E−01 |
| 100 | 3.55E−02 | −2.26E−03 | 2.17E−02 |

1. A projection objective, comprising:
a lens of a cubically crystalline material having a [110] crystal orientation that is oriented at an angle of at most 15° relative to an optical axis of the projection objective; and
a polarization correction element comprising two subelements of birefringent, optically uniaxial material, at least one of the two subelements having an aspheric surface,
wherein:
during use of the projection objective, the polarization correction element at least partially compensates for an intrinsic birefringence of the lens; and
the projection objective is configured to be used in a microlithographic projection exposure apparatus.

2. (canceled)

3. The projection objective according to claim 1, wherein the projection objective comprises precisely one lens of the cubically crystalline material having a [110] crystal orientation that is oriented at an angle of at most 15° relative to the optical axis of the projection objective.

4. The projection objective according to claim 1, wherein the projection objective comprises a plurality of lenses of the cubically crystalline material, each of the lenses of the cubically crystalline material having a [110] crystalline orientation that is oriented at an angle of at most 15° relative to the optical axis of the projection objective.

5. The projection objective of claim 1, wherein the [110] crystal orientation of the cubically crystalline material is oriented at an angle of at most of 10° relative to the optical axis of the projection objective.

6. The projection objective according to claim 1, wherein the polarization correction element is arranged at least in the immediate proximity of a pupil plane of the projection objective.

7. The projection objective according to claim 1, wherein the projection objective has an image plane side, and the lens is the last lens of the projection objective on the image plane side of the projection objective.

8. The projection objective according to claim 1, wherein the projection objective has an object plane side, and the lens has a lens surface that is convexly curved on the object plane side of the projection objective.

9. The projection objective according to claim 1, wherein the lens is a planoconvex lens.

10. The projection objective according to claim 1, wherein the optical crystal axes of at least two subelements of the polarization correction element are oriented differently from each other.

11. The projection objective according to claim 1, wherein the polarization correction element comprises at least three subelements of birefringent, optically uniaxial material, and at least one of the at least three subelements has an aspheric surface.

12. (canceled)

13. The projection objective according to claim 1, wherein the polarization correction element comprises precisely three subelements of birefringent, optically uniaxial material, and each of the three subelements has at least one aspheric surface.

14. The projection objective according to claim 1, wherein the two subelements of the polarization correction element are arranged in direct succession along the optical axis of the projection objective.

15. The projection objective according to claim 1, wherein the optical crystal axes of at least two subelements of the polarization correction element are oriented in a plane perpendicular to the optical axis of the projection objective.

16. The projection objective of claim 1, wherein the optical crystal axis of at least one subelement of the two subelements of the polarization correction element is oriented parallel to the optical axis of the projection objective.

17. The projection objective according to claim 1, further comprising at least one additional polarization correction element.

18. (canceled)

19. (canceled)

20. The projection objective according to claim 1, further comprising a subsystem comprising two concave mirrors.

21. The projection objective according to claim 1, wherein the projection objective comprises a catadioptric subsystem arranged between two refractive subsystems.

22. An apparatus, comprising:
an illumination system; and
a projection objective according to claim 1,
wherein the apparatus is a microlithographic projection exposure apparatus.

23. A process, comprising:
using a microlithographic projection exposure apparatus to manufacture a microstructured component,
wherein the microlithographic projection exposure apparatus comprises:
an illumination system; and
a projection objective according to claim 1.

24. (canceled)

25. (canceled)
